(19) United States
(12) Patent Application Publication
(10) Pub. No.: US 2026/0350028 A1
(43) Pub. Date: Nov. 5, 2026

(54) QUERY-AWARE FLOW DIFFUSION FOR SCHEMA LINKING AND RETRIEVAL-AUGMENTED GENERATION

(71) Applicant: SAMSUNG SDS AMERICA, INC., San Jose, CA (US)

(72) Inventors: Davoud ATAEE TARZANAGH, Mountain View, CA (US); Sima DIDARI, San Jose, CA (US); Zhuoping ZHOU, Philadelphia, PA (US); Wenjun HU, Bellaire, TX (US); Oxana VERKHOLYAK, Arlington, VA (US); Baruch GUTOW, Baltimore, MD (US); Masoud FARAKI, Mountain View, CA (US); Heng HAO, San Jose, CA (US); Hankyu MOON, San Ramon, CA (US); Seungjai MIN, Sunnyvale, CA (US)

(73) Assignee: SAMSUNG SDS AMERICA, INC., San Jose, CA (US)

(21) Appl. No.: 19/358,065

(22) Filed: Oct. 14, 2025

Related U.S. Application Data
(60) Provisional application No. 63/796,485, filed on Apr. 29, 2025.
(60) Provisional application No. 63/846,862, filed on Jul. 18, 2025.

(51) Int. Cl. G06F 16/248; G06F 16/2452

(52) U.S. Cl. CPC G06F 16/248; G06F 16/24522

(57) ABSTRACT

Systems, methods, and devices for automatically enhancing retrieval-augmented generation (RAG). According to example embodiments, the system may include: a memory storage storing computer-executable instructions; and at least one processor communicatively coupled to the memory storage, wherein the at least one processor may be configured to execute the instructions to: obtain, from a user, a query in a natural language format; identify a plurality of keywords associated with the query; perform graph-based retrieval-augmented generation (RAG) based on the plurality of keywords to identify a plurality of sub-graphs from a knowledge graph relevant to the query; and generate a response to the query based on the plurality of sub-graphs.

This application is based on and claims priority under 35 U.S.C. § 119 from U.S. Provisional Patent Application No. 63/796,485, filed on Apr. 29, 2025, and U.S. Provisional Patent Application No. 63/846,862, filed on Jul. 18, 2025, in the United States Patent and Trademark Office, the disclosures of which are incorporated by reference herein in their entireties.

### BACKGROUND

### 1. Field

The present disclosure relates to retrieval-augmented generation (RAG), and more specifically, to the enhancement of graph-based RAG.

### 2. Description of Related Art

Artificial intelligence and machine learning methods have become widely implemented across many fields and industries. One major implementation of artificial intelligence and machine learning involves large language models (LLMs).

LLMs may involve various techniques and algorithms that may be used to receive, process, and provide responses to natural language texts. LLMs may be trained based on a large amount of data to recognize and understand various complex information in a natural language, such as pattern, grammar, intonation, semantics, contextual information, and the like.

LLMs may be used in a wide array of applications in many industries, including, but not limited to, translation, speech recognition, speech generation, text-to-speech, data analysis, chat bots, search engine, and the like.

### SUMMARY

Provided are systems, methods and devices for efficiently and effectively obtaining information relevant to a user query for generation of responses.

In accordance with aspect of the disclosure, an electronic device for generating query responses includes: at least one processor; and a memory storage storing instructions which, when executed by the at least one processor, cause the electronic device to: obtain, from a user, a query in a natural language format; identify a plurality of keywords associated with the query; perform graph-based retrieval-augmented generation (RAG) based on the plurality of keywords to identify a plurality of sub-graphs from a knowledge graph relevant to the query; and generate a response to the query based on the plurality of sub-graphs.

The instructions, when executed by the at least one processor, may further cause the electronic device to: segment the query into a plurality of subqueries, perform the graph-based RAG to identify multiple pluralities of sub-graphs relevant to the plurality of subqueries, and generate the response based on an aggregation of the multiple pluralities of sub-graphs.

The instructions, when executed by the at least one processor, may further cause the electronic device to: determine whether the query should be segmented into the plurality of subqueries based on a predefined criteria, and segment the query into the plurality of subqueries based on determining that the query should be segmented into the plurality of subqueries.

The instructions, when executed by the at least one processor, may further cause the electronic device to generate a plurality of summary entries describing the plurality of sub-graphs, and the response to the query may be generated based on the plurality of summary entries.

The knowledge graph may include a plurality of graph nodes and a plurality of connections between the plurality of graph nodes, and, to perform the graph-based RAG, the instructions, when executed by the at least one processor, may further cause the electronic device to select a plurality of seed nodes from the plurality of graph nodes based on relevance scores indicating relevance between the plurality of graph nodes and the plurality of keywords, and select, for each seed node from among the plurality of seed nodes, a plurality of flow-selected nodes from the plurality of graph nodes connected to the each seed node using a flow diffusion process, and the plurality of seed nodes, the plurality of flow-selected nodes, and connections between the plurality of seed nodes and the plurality of flow-selected nodes may form the plurality of sub-graphs.

The instructions, when executed by the at least one processor, may further cause the electronic device to select the plurality of flow-selected nodes using the flow diffusion process in combination with iterative mass redistribution under a push-relabel algorithm.

To select the plurality of seed nodes, The instructions, when executed by the at least one processor, may further cause the electronic device to: determine, for each graph node from among the plurality of graph nodes, a relevance level between the each graph node and each keyword from among the plurality of keywords, identify, for the each graph node, a relevance level between the each graph node and a keyword having a highest relevance level from among the plurality of keywords, wherein the highest relevance level corresponds to a relevance score of the each graph node, and select a number of graph nodes from the plurality of graph nodes having higher relevance scores than remaining graph nodes from among the plurality of graph nodes, wherein the selected number of graph nodes correspond to the plurality of seed nodes.

To select the plurality of flow-selected nodes, the instructions, when executed by the at least one processor, may further cause the electronic device to: determine an initial distribution of a plurality of source mass values by determining a source mass value corresponding to the each seed node; and perform an iterative propagation process to redistribute the plurality of source mass values through the knowledge graph; compute a plurality of importance scores based on the redistributed plurality of mass values; and select the plurality of flow-selected nodes based on a comparison between the plurality of importance scores and a predetermined threshold score, and the plurality of source mass values may be redistributed based on a plurality of query-aware edge weights that are computed based on relevance levels between connected nodes and relevance levels between the connected nodes and the query.

To perform the iterative propagation process, the instructions, when executed by the at least one processor, may further cause the electronic device to: determine a sink capacity value corresponding to the each graph node based on a degree of the each graph node; determine whether an accumulated source mass value associated with the each graph node is greater than the sink capacity value; based on determining that the accumulated source mass value is greater than the sink capacity value, compute at least one query-aware edge weight corresponding to at least one neighboring node based on a relevance level between the each identified graph node and the at least one neighboring node, a relevance level between the each identified graph node and the query, and a relevance level between the at least one neighboring node and the query; and distribute an excess mass value to the at least one neighboring node proportionally according to the at least one query-aware edge weight, and the iterative propagation process may be repeated until a total excess mass value is less than a convergence threshold value.

In accordance with aspect of the disclosure, a method for generating query responses includes: obtaining, from a user, a query in a natural language format; identifying a plurality of keywords associated with the query; performing graph-based retrieval-augmented generation (RAG) based on the plurality of keywords to identify a plurality of sub-graphs from a knowledge graph relevant to the query; and generating a response to the query based on the plurality of sub-graphs.

The method may further include segmenting the query into a plurality of subqueries, the graph-based RAG may be performed to identify multiple pluralities of sub-graphs relevant to the plurality of subqueries, the response may be generated based on an aggregation of the multiple pluralities of sub-graphs.

The method may further include determining whether the query should be segmented into the plurality of subqueries based on a predefined criteria, and the query may be segmented into the plurality of subqueries in response to determining that the query should be segmented into the plurality of subqueries.

The method may further include generating a plurality of summary entries describing the plurality of sub-graphs, and the response to the query may be generated based on the plurality of summary entries.

The knowledge graph may include a plurality of graph nodes and a plurality of connections between the plurality of graph nodes, and the performing the graph-based RAG may include: selecting a plurality of seed nodes from the plurality of graph nodes based on relevance scores indicating relevance between the plurality of graph nodes and the plurality of keywords; and selecting, for each seed node from among the plurality of seed nodes, a plurality of flow-selected nodes from the plurality of graph nodes connected to the respective seed node using a flow diffusion process, and the plurality of seed nodes, the plurality of flow-selected nodes, and connections between the plurality of seed nodes and the plurality of flow-selected nodes may form the plurality of sub-graphs.

The plurality of flow-selected nodes may be selected using the flow diffusion process in combination with iterative mass redistribution under push-relabel algorithm.

The selecting the plurality of seed nodes may include: determining, for each graph node from among the plurality of graph nodes, a relevance level between the each graph node and each keyword from among the plurality of keywords; identifying, for the each graph node, a relevance level between the each graph node and a keyword having a highest relevance level from among the plurality of keywords, wherein the highest relevance level corresponds to a relevance score of the each graph node; and selecting a number of graph nodes from the plurality of graph nodes having higher relevance scores than remaining graph nodes from among the plurality of graph nodes, wherein the selected number of graph nodes correspond to the plurality of seed nodes.

The method may further include: determining an initial distribution of a plurality of source mass values by determining a source mass value corresponding to the each seed node; performing an iterative propagation process to redistribute the plurality of source mass values through the knowledge graph; computing a plurality of importance scores based on the redistributed plurality of mass values; and selecting the plurality of flow-selected nodes based on a comparison between the plurality of importance scores and a predetermined threshold score, and the plurality of source mass values may be redistributed based on a plurality of query-aware edge weights that are computed based on relevance levels between connected nodes and relevance levels between the connected nodes and the query.

The iterative propagation process may include: determining a sink capacity value corresponding to the each graph node based on a degree of the each graph node; determining whether an accumulated source mass value associated with the each graph node is greater than the sink capacity value; based on determining that the accumulated source mass value is greater than the sink capacity value, computing at least one query-aware edge weight corresponding to at least one neighboring node based on a relevance level between the each identified graph node and the at least one neighboring node, a relevance level between the each identified graph node and the query, and a relevance level between the at least one neighboring node and the query; and distributing an excess mass value to the at least one neighboring node proportionally according to the at least one query-aware edge weight, and the iterative propagation process may be repeated until a total excess mass value is less than a convergence threshold value.

In accordance with aspect of the disclosure, a non-transitory computer-readable recording medium has recorded thereon instructions which, when executed by at least one processor of an electronic device for generating query responses, cause the electronic device to: obtain, from a user, a query in a natural language format; identify a plurality of keywords associated with the query; perform graph-based retrieval-augmented generation (RAG) based on the plurality of keywords in order to identify a plurality of sub-graphs from a knowledge graph relevant to the query; and generate a response to the query based on the plurality of sub-graphs.

The instructions, when executed by the at least one processor, may further cause the electronic device to segment the query into a plurality of subqueries, the graph-based RAG may be performed to identify multiple pluralities of sub-graphs relevant to the plurality of subqueries, and the response may be generated based on an aggregation of the multiple pluralities of sub-graphs.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a flow diagram of an example process for enhancing retrieval-augmented generation (RAG), according to one or more example embodiments;

FIG. 2 illustrates an example knowledge graph, according to one or more example embodiments;

FIG. 3 illustrates a flow diagram of an example process for creating knowledge graph, according to one or more example embodiments;

FIG. 4 illustrates an example visual representation of an example process, according to one or more example embodiments;

FIG. 5 illustrates a flow diagram of an example process for performing graph-based RAG, according to one or more example embodiments;

FIG. 6 illustrates an example knowledge graph containing a plurality of subgraphs, according to one or more example embodiments;

FIG. 7 illustrates a flow diagram of an example process for selecting a plurality of seed nodes, according to one or more example embodiments;

FIG. 8 illustrates an example algorithm for selecting a plurality of seed nodes, according to one or more example embodiments;

FIG. 9 illustrates a flow diagram of an example process for selecting a plurality of flow-selected nodes, according to one or more example embodiments;

FIG. 10 illustrates an example algorithm for selecting a plurality of flow-selected nodes of a particular seed node, according to one or more example embodiments;

FIG. 11 illustrates a flow diagram of an example process for enhancing retrieval-augmented generation (RAG), according to one or more example embodiments;

FIG. 12 illustrates a flow diagram of an example process for enhancing retrieval-augmented generation (RAG), according to one or more example embodiments;

FIG. 13 illustrates a flow diagram of an example process for enhancing text-to-SQL, according to one or more example embodiments;

FIG. 14 illustrates a flow diagram of an example process for creating schema graph, according to one or more example embodiments;

FIG. 15A to FIG. 15B illustrate example plurality of entries and plurality of relationships, according to one or more example embodiments;

FIG. 16 illustrates a flow diagram of an example process for identifying a plurality of paths, according to one or more example embodiments;

FIG. 17A and FIG. 17B illustrate example algorithms for identifying a plurality of paths, according to one or more example embodiments;

FIG. 18 illustrates an example visual representation of an example process, according to one or more example embodiments; and

FIG. 19 illustrates a block diagram of example components in a system, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

As described above, the LLM may be trained based on a large amount of data to recognize and understand various complex information in a natural language. In this regard, the present disclosure may provide enhancements and improvements to LLM in several different areas, for example improvement of graph-based retrieval-augmented generation (RAG) processes with unstructured data, and text-to-SQL processes with structured data.

The RAG process may refer to a framework that integrates the LLM with external knowledge (data) sources, allowing the LLM to access information beyond the LLM's pre-existing training data to generate responses.

In particular, LLMs may remain prone to hallucinations and lack of domain knowledge. Text-based RAG may reduce these issues by supplementing LLMs with unstructured external data. These systems may employ sparse or dense retrieval, but most may treat text as flat segments, missing critical context and inter-document relationships.

In this regard, with general RAG systems, a retrieval component may identify pertinent information according to user queries, which may be subsequently merged with the initial input and forwarded to the generation component for producing the final response. This process may prove especially beneficial for question-answering (QA) tasks, where supplementary factual information strengthens output precision, particularly within critical fields such as healthcare, legal, financial, educational applications, and the like. Contemporary developments in LLMs positioned RAG as fundamental to ethical AI implementation, tackling essential challenges such as minimizing hallucinations, enhancing transparency, facilitating adaptability, safeguarding privacy, advancing fairness, and maintaining reliability.

Although some RAG may demonstrate effectiveness with unstructured document retrieval, real-world knowledge frequently exhibits graph-structured characteristics and spans database schemas, social networks, and biomedical knowledge repositories. These architectures preserve rich relational information that some retrieval processes may fail to capture, such as multi-hop dependencies, hierarchical associations, intricate interaction patterns, and the like.

Graph-based RAG processes may exploit these characteristics by integrating graph-based techniques including community detection and graph neural networks, advancing beyond similarity-based search to encompass topological and semantic relationships. This enables sophisticated multi-hop reasoning essential for complex tasks such as text-to-SQL generation, scientific discovery, and medical diagnosis, where understanding relationships is as crucial as retrieving individual facts.

In particular, KG-RAG enhances interpretability and factuality by leveraging structured knowledge graphs. These systems utilize curated or optimized graphs to retrieve entity and relational context, typically extracting local subgraphs relevant to a query. However, most KG-RAG processes focus on single-hop or shallow queries and struggle with scale and multi-step reasoning.

Among training-intensive approaches, QA-GNN combines pre-trained language models and knowledge graphs by using LM-based relevance scoring to select pertinent KG nodes, followed by joint graph neural reasoning for accurate and interpretable question answering. Certain solutions in the related art proposed knowledge-aware neural retrievers for incomplete KBs. Other works in the related art, such as SubgraphRAG, train end-to-end retrieval modules to extract relevant KG subgraphs for downstream LLM reasoning. Several studies have also integrated knowledge graph structure directly into transformers for enhanced QA, and KnowGPT leverages KG-based prompting for LLMs. However, these processes may require substantial supervised data and retraining.

Recent work has explored training-free KG-RAG processes, building text-associated graphs to support more complex and multi-hop queries. For instance, GraphRAG applies community detection to cluster entities, while LightRAG uses multi-stage retrieval and ego-network aggregation. PathRAG further improves graph-based RAG by retrieving key relational paths rather than redundant neighborhood information, using flow-based pruning to identify reliable paths and strategic prompt organization to enhance LLM responses. However, all aforementioned processes may still struggle to precisely align query intent with relevant regions of the graph, making it difficult to identify semantically coherent reasoning subgraphs. Furthermore, existing RAG approaches generally lack statistical or optimization guarantees, as well as complexity analysis, for their retrieval mechanisms.

For example, graph-based RAG processes may have the following shortcomings. Graph-based RAG processes may predominantly employ heuristic subgraph search strategies that are largely query-agnostic during graph navigation. This limitation is evident in several ways. For example, GraphRAG may apply uniform community detection and retrieve entire clusters regardless of query relevance, LightRAG may extract complete ego-networks only from entities directly around seed nodes without considering semantic or structural alignment, and PathRAG may use fixed path-based pruning with constant decay rates across all query types.

Here, an example is provided. A user query may be provided to a naive (e.g., non-graph-based) RAG and a standard graph-based RAG. The user query may include “How does climate change affect coral reef bleaching?”

In this regard, five documents may be provided as external knowledge sources. The following provide general document corpus and thematically related passages of said documents describing climate change, coral biology, and bleaching mechanisms.

Document A may describe “Global Warming Overview. Climate change has caused a steady increase in average global temperatures over the past century . . . ”, document B may describe “Ocean Chemistry. Ocean acidification, driven by rising CO₂ levels, affects marine organisms such as shellfish and plankton . . . ”, document C may describe “Coral Physiology. Corals maintain symbiotic relationships with zooxanthellae, which are sensitive to environmental stress . . . ”, document D may describe “Coral Bleaching Process. When sea temperatures rise above normal, corals expel their symbiotic algae, . . . coral bleaching . . . ”, and document E may describe “Marine Ecosystem Impact. Bleaching events can lead to widespread coral mortality, disrupting the entire reef ecosystem . . . ”

In this regard, the naive RAG process may involve retrieval of documents based purely on keyword and/or embedding similarity (e.g., top-K similarity score). In particular, document A, document C, and document B may have the highest similarity scores of 0.9, 0.8, and 0.7 respectively, and may be retrieved for processing. Here, the naive RAG process may provide a response “Climate change increases global temperatures. Ocean acidification also affects marine life. Corals are sensitive organisms that can be harmed by environmental changes”. As shown, while the top-ranked documents are superficially relevant, the generated answer may be fragmented and lack causal or mechanistic detail. More specifically, no causal link is established, no mention of bleaching, and poor logical structure.

The standard graph-based RAG may provide improvement over the naive RAG by leveraging inter-document structure, but its retrieval may still remain query-agnostic. In particular, graph-based RAG may identify broad semantic information of each of the documents and their interrelationships, where document A may be identified with “climate change”, document E may be identified with “ecosystem impact”, and document C may be identified with “coral physiology”, and may be selected for processing. As a result, it may activate semantically broad content (e.g., ecosystem or physiology) while missing the specific causal chain needed to answer the query precisely. More specifically, the response may lack details on mechanisms, while being unclear and vague.

In view of the above, the query-agnostic strategies utilized in graph-based RAG processes in the related art may lead to the inclusion of irrelevant nodes due to structural proximity, the omission of relevant but distant information because of rigid boundaries, and the generation of unstructured entity lists rather than coherent reasoning paths. Moreover, lacking theoretical foundations, these heuristic approaches often result in unpredictable performance. In other words, graph-based RAG processes in the related art may generate large amount of irrelevant noise, leading to unnecessarily high computational cost and inaccurate results.

In other words, the graph-based RAG processes in the related art may leverage interconnected knowledge structures to represent complex relationships within large-scale heterogeneous information systems, enabling structured reasoning that some flat RAG approaches struggle to achieve. Nevertheless, the graph-based RAG processes in the related art may suffer from static exploration strategies that apply uniform search patterns regardless of query semantics, resulting in inefficient retrieval and reasoning performance.

Separately, a flow diffusion process may describe the process of spreading mass from one or more seed nodes to neighboring nodes along graph edges. The empirical and theoretical performance of local diffusion processes may typically be evaluated in the context of local graph clustering.

In the related art, local graph clustering was introduced by using a random-walk algorithm, with later employing personalized PageRank. Most works analyze these processes via output conductance. Statistical analysis appeared for el-regularized PageRank, though attributed graphs remain unaddressed. Community/cluster detection methods that combine structure and node or edge attributes benefit from this integration but require global processing, making them unsuitable for local clustering. Contextual random graph models have been employed for attributed community detection, node separability, and analysis of graph convolutions and optimal classifiers. Related anomaly detection and estimation processes also focus on scalar data and global processing.

Accordingly, there is a need for an improved graph-based RAG process that is query-aware and is capable of addressing one or more shortcomings of the graph-based RAG processes in the related art described above. In certain implementation, such improved graph-based RAG process may utilize the flow diffusion process to address one or more shortcomings of the graph-based RAG processes in the related art.

The text-to-SQL process may refer to a process that translates natural language texts into executable structured query language (SQL), which has emerged as a critical capability for democratizing data access in modern enterprises.

In particular, databases utilized in organizations (e.g., modern enterprises, educational institutions, etc.) may contain various kinds of data that may be arranged in a structured format, such as data tables. In this regard, user queries may be obtained and transformed from a natural language into the SQL, where said SQL may be utilized to search and explore relevant information in the databases.

With most organizational data residing in relational databases, SQL remains the primary language for data access and manipulation of said relational databases. In this regard, the advent of LLMs has accelerated progress in this field, enabling systems to handle increasingly complex user queries.

Nevertheless, text-to-SQL processes in the related art, such as Spider 1.0, Spider 2.0, and BIRD, continue to struggle with enterprise-scale databases. In particular, the main challenge may lie in identifying portions of the database (e.g., data tables) that are relevant to the user query, which may be difficult with enterprise-scale databases.

Here, the difficulty may stem from several critical characteristics of enterprise databases, including, but not limited to: (1) massive schemas with thousands of columns across multiple tables; (2) dialect-specific functions requiring specialized syntax; (3) undocumented joins lacking explicit foreign key relationships; and (4) complex query planning involving multiple Common Table Expressions (CTEs), nested subqueries, and advanced analytics.

The text-to-SQL processes in the related art fail to address these challenges effectively. Prompt-based and retrieval-augmented processes struggle with implicit semantic connections, particularly latent joins, while also incurring prohibitive computational costs due to excessive LLM calls. For example, the Spider-Agent process typically requires 10-20 LLM calls merely to explore the schema, while processes such as CHESS and CHASE-SQL may require a number of LLM calls proportional to the number of tables and columns (e.g., entries) in the enterprise databases, rendering them impractical for large-scale enterprise production use cases.

More specifically, researches associated with text-to-SQL processes increasingly rely on both model adaptation and prompt engineering to leverage large language models. In this regard, fine-tuning techniques, such as those employed in RAT-SQL, PICARD, RESDSQL, CodeS, and PSM-SQL, may train models to incorporate schema details and enforce logical consistency. Alternatively, prompt-driven strategies, such as those employed in ACT-SQL, DIN-SQL, CHESS, and CHASE-SQL, may leverage carefully designed instructions to enable zero or few-shot generalization. Recent solutions in the related art also span areas such as semantic schema linking, context-aware prompting, modular query breakdown, iterative memory-based correction, and techniques for calibrating model confidence. While these approaches have led to strong performance on benchmarks like Spider 1.0 and BIRD, handling the increased complexity of Spider 2.0 remains an open challenge.

Certain solutions in the related art have applied reinforcement learning (RL) to improve SQL generation. For example, Seq2SQL uses policy gradients and execution feedback for clause refinement, while ICRL leverages retrieval-based in-context learning with reward signals. SQL-RL-GEN and STaR-SQL utilize evolutionary optimization and reward shaping, respectively. DeepSQL-R1 introduces efficient RL via LoRA and quantization, and Reasoning-RL combines schema-linking with similarity-based rewards. SQL-R1 further advances RL-based reasoning for multi-table and nested queries through dynamic reward strategies.

Certain solutions in the related art have also implemented agent-based coding systems to significantly advance language model reliability and flexibility by integrating reasoning, tool use, and iterative correction. ReAct is a prominent approach that blends reasoning with action, and Spider Agent builds on this framework for database-focused tasks. Multi-agent and workflow-based strategies, including collaborative planning and structured task decomposition, further support complex coding. While general agents provide flexibility, domain-specific solutions often outperform them. Inspired by Chain-of-Thought and related ideas, newer frameworks have improved automation and modularity. For large-scale database tasks in Spider 2.0, ReFORCE combines iterative exploration and schema compression to address enterprise SQL needs. However, its coarse-grained schema discovery retains or discards entire tables, failing to link precise columns and foreign-key paths, preserving irrelevant attributes while missing critical joins in complex queries.

Graph representations are central to recent text-to-SQL processes, greatly improving schema linking and SQL generation. RATSQL models database schemas as graphs of tables and columns connected by relational edges. LGESQL introduces edge-focused modeling for complex schemas, while S2SQL leverages syntactic dependency graphs for enhanced question-schema interaction. Graphix-T5 integrates graph neural networks with T5 transformers for structural and semantic reasoning. RESDSQL uses a ranking-based encoder to prioritize schema elements for decoding, and Structure-Guided SQL combines syntax aware prompting with dual-graph encodings for deeper schema understanding. ISESL-SQL iteratively builds a semantic schema-linking graph to boost generalization. Dual graph aggregation network further enhances cross-domain performance by modeling both questions and schemas as graphs, capturing global and local linkages for robust question-schema mapping. However, nearly all existing graph-based processes require substantial training.

Accordingly, there is a need for an improved text-to-SQL process that is able to minimize inference latency and cost, while preserving or improving query-generation accuracy in text-to-SQL tasks for large and complex enterprise schemas.

It is contemplated that features, advantages, and significances of example embodiments described herein are merely a portion of the present disclosure, and are not intended to be exhaustive or to limit the scope of the present disclosure. Further descriptions of the features, components, configuration, operations, and implementations of the example embodiments of the present disclosure are provided in the following.

Here, example embodiments of the present disclosure may be performed by a query processing (QP) system. The QP system may be configured to obtain a query from a user, process the query to understand the query, and provide a response to the query to the user.

According to example embodiments, the QP system may include an apparatus, a system, a platform, a module, or the like, which may be configured to perform one or more operations or actions for enhancing RAG. In particular, the QP system may be configured to utilize RAG process in order to receive, process, and provide the response to the query. According to example embodiments, the QP system may utilize a graph-based RAG process, which may involve two stage: indexing stage and query stage.

The indexing stage may involve obtaining documents containing certain unstructured information, and processing said documents in order to generate a knowledge graph. Said knowledge graph may be utilized during the query stage in order to understand the query from the user and generate appropriate responses. In other words, the indexing stage may construct a domain-specific knowledge graph by extracting entities, relations, and document-level structure from raw corpus data.

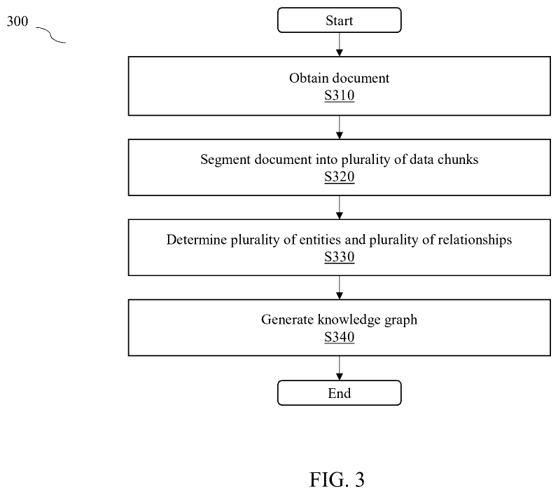

Examples of operations associated with the indexing stage are described below with reference to FIG. 3.

The query stage may involve obtaining a natural language query from a user, processing the query to understand the query, and providing a response to the query. In this regard, the query stage may also involve traversing the knowledge graph in order to extract relevant information and prepare appropriate responses to the query based on the extracted information. In other words, the query stage may process an incoming user query in several steps: namely keyword extraction that may identify query-relevant dual-level keywords; query-aware flow diffusion algorithm that may propagate selected seed nodes over the graph based on semantic and structural signals; cluster collection for each seed node, where each cluster is summarized into natural language; and response generation where cluster summaries, along with the original query, are passed to a language model for final response generation.

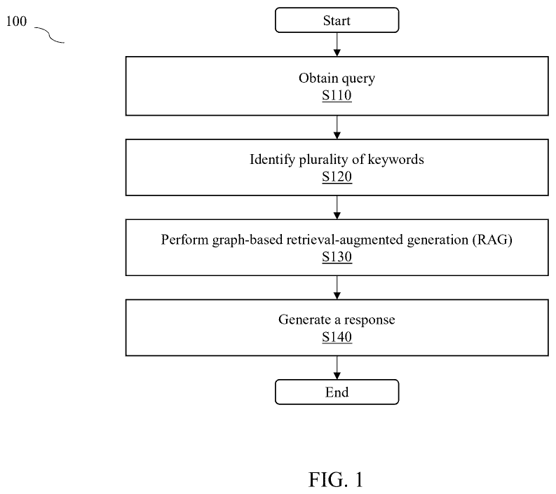

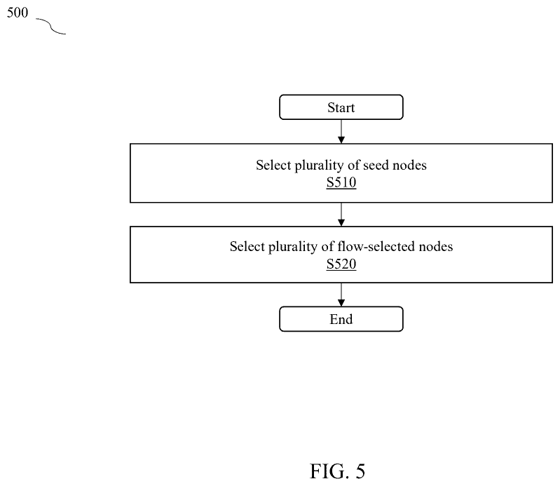

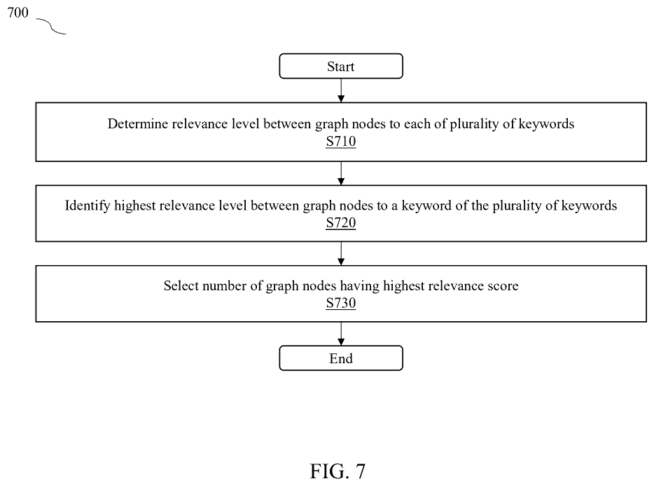

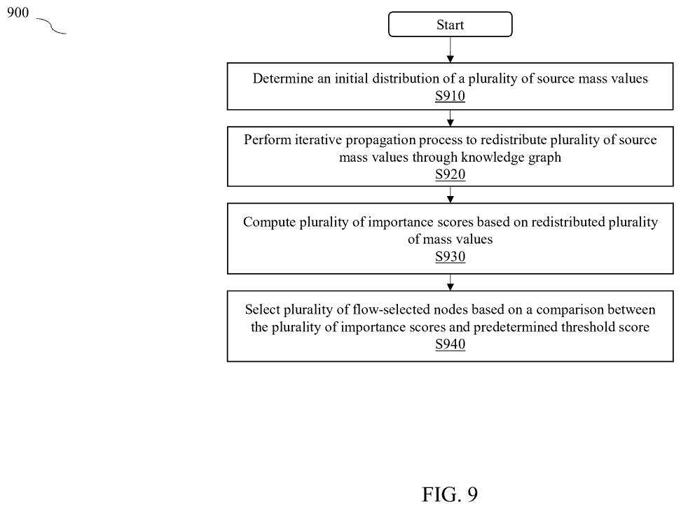

Examples of operations associated with the query stage are described below with reference to FIG. 1, FIG. 5, FIG. 7, and FIG. 9.

According to example embodiments, the QP system may include an apparatus, a system, a platform, a module, or the like, which may be configured to perform one or more operations or actions for enhancing text-to-SQL. In particular, the QP system may be configured to utilize text-to-SQL process in order to receive, process, and provide the response to the query. According to example embodiments, the QP system may utilize a graph-based text-to-SQL process, which may involve two stage: schema inferencing stage and query stage.

The schema inferencing stage may involve obtaining data from a database containing certain structured information, and processing said data in order to generate a schema graph. Said schema graph may be utilized during the query stage in order to understand the query from the user and generate appropriate responses.

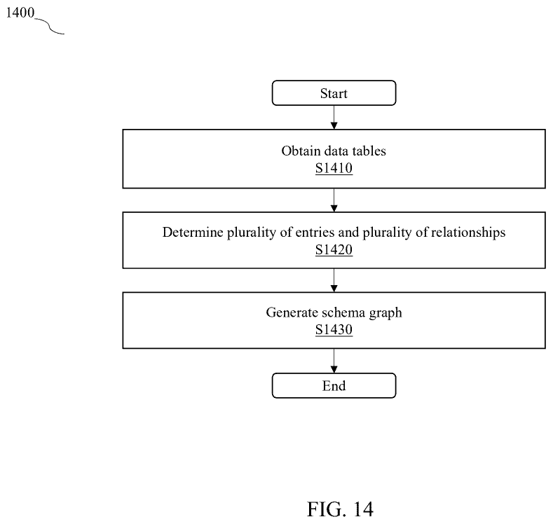

Examples of operations associated with the schema inferencing stage are described below with reference to FIG. 14.

The query stage may involve obtaining a natural language query from a user, processing the query to understand the query, and providing a response to the query. In this regard, the query stage may also involve traversing the schema graph in order to extract relevant information and prepare appropriate responses to the query based on the extracted information.

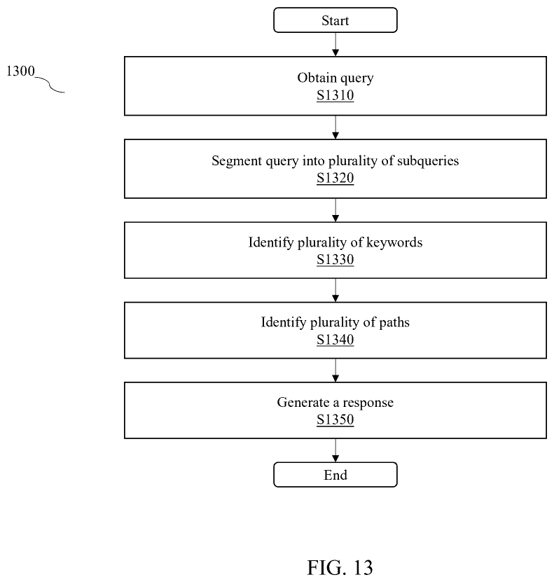

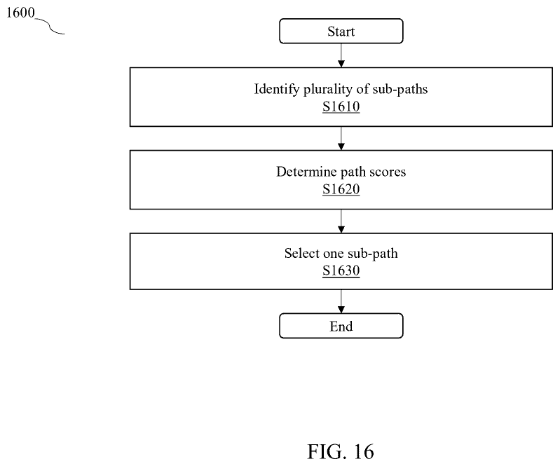

Examples of operations associated with the query stage are described below with reference to FIG. 13 and FIG. 16.

FIG. 1 illustrates a flow diagram of an example process 100 for enhancing RAG, according to one or more example embodiments. One or more operations in process 100 may be performed by at least one processor (e.g., processor 1912) of the QP system.

As illustrated in FIG. 1, at operation S110, the at least one processor may be configured and/or programmed to obtain a query. The query may be obtained from a user and may be in a natural language format.

Here, the query may be obtained from the user using any appropriate process, technique, tools, and the like. For example, The QP system may be communicatively coupled to a user equipment (UE) of the user, where the user may input the query into a graphical user interface at the UE, and the UE may transmit the query to the QP system via a wireless connection.

For example, the query may be “What role does feminism play in the book's analysis of Elaine Benes?” The process then proceeds to operation S120.

At operation S120, the at least one processor may be configured and/or programmed to identify a plurality of keywords associated with the query.

According to example embodiments, the plurality of keywords may include high-level keyword and low-level keyword. The high-level keyword may include keyword capturing broad conceptual ideas, such as “politics”, “relationship”, “individualism”, “feminism”, and the like. The low-level keyword may include keyword capturing specific details, such as a name of a person, a name of a company, a name of a place, a specific time, a specific value, and the like.

It is noted here that the plurality of keywords may include terms explicitly stated in the query and/or terms inherently/implicitly stated in the query.

In this regard, for example, the high-level keyword associated with the query “What role does feminism play in the book's analysis of Elaine Benes?” may include “feminism”, “philosophy”, and “character evaluation”, while the low-level keyword may include “Elaine Benes”, “book analysis”, “gender roles”, and “social commentary”.

According to example embodiments, the plurality of keywords may be identified using a large language model (LLM). According to example embodiments, the plurality of keywords may be identified using the LLM and a prompting technique based on a first prompt. The prompting technique may involve providing a prompt specifying various information and operations to be performed by the LLM, such as goals, steps, roles, and the like.

According to example embodiments, the first prompt may specify a role of the LLM, a goal, and a plurality of instructions to identify the plurality of keywords to the LLM, where the LLM may perform operations in accordance with the prompt.

For example, the role may specify “You are a helpful assistant tasked with identifying both high-level and low-level keywords in the user's query”.

Further, the goal may specify “Given the query, list both high-level and low-level keywords. High-level keywords focus on overarching concepts or themes, while low-level keywords focus on specific entities, details, or concrete terms”.

Furthermore. The instructions may specify “(1) Output the keywords in JSON format; (2) The JSON should have two keys: “high_level_keywords” for overarching concepts or themes, and “low_level_keywords” for specific entities or details”.

Here, the identification/extraction of keywords may ensure comprehensive coverage of query semantics. The process then proceeds to operation S130.

At operation S130, the at least one processor may be configured and/or programmed to perform graph-based RAG. The graph-based RAG may be performed based on the plurality of keywords in order to identify a plurality of sub-graphs from a knowledge graph relevant to the query.

According to example embodiments, the knowledge graph (knowledge graph representation) may include a plurality of graph nodes and a plurality of connections between the plurality of graph nodes. The plurality of graph nodes may represent a plurality of entities, while the plurality of connections may represent a plurality of relationships between the plurality of entities.

In this regard, the QP system may perform the graph-based RAG to identify a plurality of sub-graphs, which may include a number of nodes and a number of connections from the plurality of graph nodes and the plurality of connections in the knowledge graph. Here, the nodes and connections in the identified plurality of sub-graphs may be most relevant to the query in comparison to other nodes and connections in the knowledge graph.

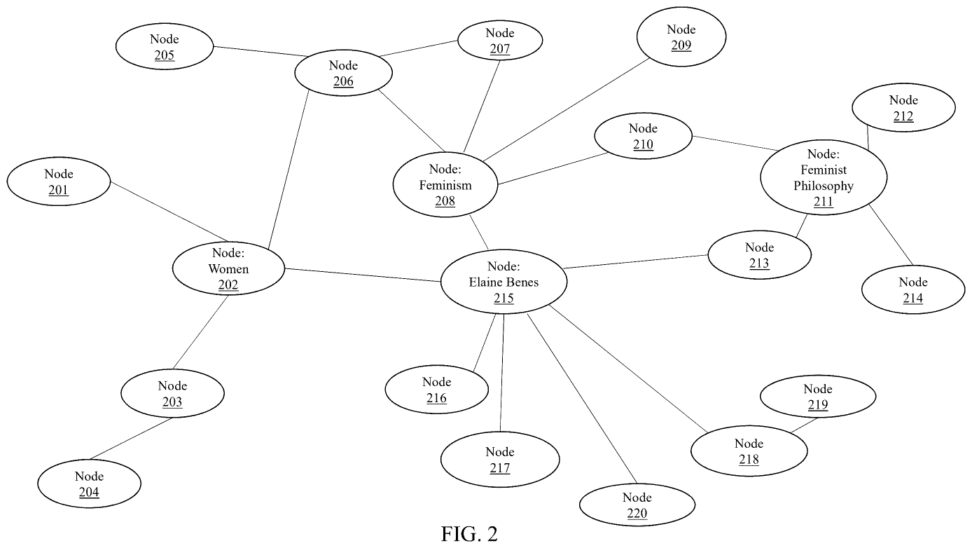

FIG. 2 illustrates an example knowledge graph, according to one or more example embodiments. As shown in FIG. 2, the knowledge graph may include a plurality of graph nodes 201-220, and a plurality of connections between the plurality of graph nodes 201-220.

The plurality of graph nodes may represent a plurality of entities. The plurality of entities here may include any kind of entities, such as key concepts/idea, named person, named location, and the like. In the example shown in FIG. 2, graph node 202 represents an entity “Women”, graph node 208 represents an entity “Feminism”, graph node 215 represents an entity “Elaine Benes”, and graph node 211 represents an entity “Feminist Philosophy”. It is understood here that while FIG. 2 only shows the entities represented by graph nodes 202, 208, 215, and 211, other graph nodes may represent other entities not shown in FIG. 2.

Further, the plurality of connections may represent a plurality of relationships between the plurality of entities. The plurality of relationships may include any kind of relationships, such as association type, semantic relationship, and the like. In the example shown in FIG. 2, the connection between graph node 202 representing “Women” and graph node 215 representing “Elaine Benes” may represent a relationship indicating that Elaine Benes is a women. Similarly, the connection between graph node 215 representing “Elaine Benes” and graph node 208 representing “Feminism” may represent a relationship indicating that Elaine Benes has feminism ideology.

In this regard, the QP system may perform the graph-based RAG to identify a plurality of sub-graphs relevant to the query “What role does feminism play in the book's analysis of Elaine Benes?”, which may include for example, a first sub-graph including graph node 208 (feminism), graph node 206, and graph node 207; a second sub-graph including graph node 215 (Elaine Benes), graph node 216, graph node 213, graph node 218, and graph node 219; a third sub-graph including graph node 211 (feminist philosophy), graph node 213, graph node 210, and graph node 212; and a fourth sub-graph including graph node 202 (women), graph node 201, graph node 203, and graph node 204.

It is understood that the example shown in FIG. 2 is provided for descriptive purpose, and is not intended to limit the scope of the present disclosure in any way. For example, the number of graph nodes and connections can be any, the graph nodes and connections can be in any configuration and arrangements, the graph node may correspond to any kind of entity, the connection may correspond to any kind of relationship, and the like.

According to example embodiments, the knowledge graph may be created by the QP system based on documents containing certain unstructured information (e.g., a book analysis of Elaine Benes mentioned in the query). Examples of operations for creating the knowledge graph are described below with reference to FIG. 3.

According to example embodiments, the at least one processor may be configured and/or programmed to perform the graph-based RAG by: selecting a plurality of seed nodes from the plurality of graph nodes based on relevance scores indicating relevance between the plurality of graph nodes and the plurality of keywords; and selecting, for each seed node of the plurality of seed nodes, a plurality of flow-selected nodes from the plurality of graph nodes having connections to the respective seed node (e.g., to the each seed node) using a flow diffusion process. Here, the plurality of seed nodes, the plurality of flow-selected nodes, and connections connecting the plurality of seed nodes and the plurality of flow-selected nodes to each other form the plurality of sub-graphs.

According to example embodiments, the at least one processor may be configured and/or programmed to select the plurality of flow-selected nodes using the flow diffusion process in combination with iterative mass redistribution under push-relabel algorithm.

Examples of operations for performing the graph-based RAG are described below with reference to FIG. 5, FIG. 7, and FIG. 9. The process then proceeds to operation S140.

At operation S140, the at least one processor may be configured and/or programmed to generate a response to the query based on the plurality of sub-graphs.

Here, the response may include any kind of response to the query, such as an answer. Further, the response may be in the natural language format.

According to example embodiments, the response may be generated using the LLM. According to example embodiments, the response may be generated using the LLM and the prompting technique based on a second prompt.

According to example embodiments, the second prompt may specify a role of the LLM, a goal, a target response, and a data table associated with generation of the response to the LLM, where the LLM may perform operations in accordance with the prompt.

For example, the role may specify “You are a helpful assistant responding to questions about the data in the tables provided”.

Further, the goal may specify “Generate a response of the target length and format that responds to the user's question, summarizing all information in the input data tables appropriate for the response length and format, and incorporating any relevant general knowledge. If you don't know the answer, just say so. Do not make anything up. Do not include information where the supporting evidence for it is not provided”.

Furthermore, the target response may specify “{response_type}”, and the data table may specify “{context_data}”. The second prompt may also specify a note, such as “Add sections and commentary to the response as appropriate for the length and format. Style the response in markdown”.

In this regard, it is understood that the response may be generated using the LLM using any appropriate process, technique, tools, and the like. For example, the QP system may simply forward the plurality of sub-graphs to the LLM. Accordingly, the LLM may process the sub-graphs and provide the response to the QP system.

According to example embodiments, the at least one processor may be configured and/or programmed to also provide the generated response to the user. Here, the generated response may be provided to the user using any appropriate process, technique, tools, and the like. For example, The QP system may be communicatively coupled to a user equipment (UE) of the user, where the QP system may transmit the generated response to a graphical user interface at the UE via a wireless connection.

Upon performing operation S140, the process 100 may be ended or be terminated. Alternatively, process 100 may return to operation S110, such that the at least one processor may be configured and/or programmed to repeatedly perform, for at least a predetermined amount of time, the obtaining the query (at operation S110), the identifying the plurality of keywords (at operation S120), the performing the graph-based RAG (at operation S130), and the generating the response (at operation S140). For instance, the at least one processor may continuously (or periodically) receive more queries from the user (same user or different users), and then restart the obtaining the query (at operation S110), the identifying the plurality of keywords (at operation S120), the performing the graph-based RAG (at operation S130), and the generating the response (at operation S140).

In view of the above, the above processes may enable efficient information extraction from the documents through the knowledge graph, while reducing the amount of noises, which may lead to a more meaningful, accurate and query-aware response to the user query.

In particular, example embodiments of the present disclosure according to the above processes may provide a query-aware flow diffusion graph-based RAG, which may leverage interconnected knowledge structures to represent complex relationships within large-scale heterogeneous information systems, without the limitations from the graph-based RAG in the related art.

More specifically, example embodiments of the present disclosure may provide a framework that introduce dynamic, query-aware graph traversal through mathematically grounded flow diffusion mechanisms. Unlike existing processes that rely on fixed neighborhood retrieval or predetermined community detection, example embodiments of the present disclosure may dynamically adapt its exploration strategy by incorporating query semantics directly into the diffusion process by aligning the edge weights to the semantic content.

This approach may enable the construction of semantically coherent reasoning subgraphs specifically tailored to each query's requirements. Statistical guarantees on the performance of the example embodiments of the present disclosure and target subgraph recovery has been achieved. Comprehensive experiments across question-answering and text-to-SQL tasks has also demonstrated that example embodiments of the present disclosure consistently outperforms existing RAG baselines in the related art across multiple benchmarks.

In addition, none of the works related to the flow diffusion in the related art described above connect the graph structure to the query. Example embodiments of the present disclosure may provide a principled framework that links a given query to the corresponding subgraph in a knowledge graph, and develop and statistically analyze query-aware flow diffusion in general contextual random graph models with formal recovery guarantees.

FIG. 3 illustrates a flow diagram of an example process 300 for creating knowledge graph, according to one or more example embodiments. One or more operations in process 300 may be performed by at least one processor (e.g., processor 1912) of the QP system.

As illustrated in FIG. 3, at operation S310, the at least one processor may be configured and/or programmed to obtain a document.

The document may include certain information, and may be in any format, such as a book, an article, a list, and the like. According to example embodiments, information in the document may be in natural language format. According to example embodiments, the document may contain unstructured data.

For example, the document may include a book titled “Elaine Benes Analysis on Feminism”, and may include written texts related to Elaine Benes and her feminist ideology.

It is understood that the document may be obtained using any appropriate process, technique, tool, and the like. For example, the book may be converted from a hard copy into a software format using a scanner, where the software format of the book may be provided to the QP system via a memory stick. The process then proceeds to operation S320.

At operation S320, the at least one processor may be configured and/or programmed to segment the document into a plurality of data chunks.

The plurality of data chunks may represent various portions of information contained in the document. For example, the plurality of data chunks may correspond to a plurality of chapters in a book (document), a plurality of paragraphs/sentences in a chapter (document), a plurality of sections in an article (document), a plurality of bullet points in the list (document), and the like.

Here, the plurality of data chunks may contain semantically coherent chunks that preserve contextual information while enabling granular retrieval. Each of the plurality of data chunks may maintain sufficient context to be independently meaningful while being small enough for efficient processing.

According to example embodiments, the document may be segmented into the plurality of data chunks using the LLM.

Here, the document may be segmented into the plurality of data chunks in accordance with any standards, criteria, and the like. For example, document may be segmented into the plurality of data chunks based on the token input size limit of the LLM (e.g., the document is segmented into the plurality of data chunks to satisfy the token size limit). The process then proceeds to operation S330.

At operation S330, the at least one processor may be configured and/or programmed to determine, for each data chunk of the plurality of data chunks, a plurality of entities and a plurality of relationships between the plurality of entities in the respective data chunk (e.g., in the each data chunk).

For example, the book “Elaine Benes Analysis on Feminism” may include a plurality of chapters, and may be segmented in the plurality of data chunks corresponding to the plurality of chapters during operation S320. In this regard, during operation S330, the QP system may determine a plurality of entities within a first chapter (data chunk) and a plurality of relationships between the plurality of entities within the first chapter, determine a plurality of entities within a second chapter (data chunk) and a plurality of relationships between the plurality of entities within the second chapter, and the like.

In addition, for example, the first chapter may describe Elaine Benes' early life and her upbringing. Accordingly, the plurality of entities within the first chapter may be identified as Elaine Benes herself, her father, her mother, her friends, her hometown, her school, and the like, where the plurality of relationships may include a relationship between Elaine Benes herself and her father identified as family, a relationship between Elaine Benes herself and her friend identified as friend, a relationship between Elaine Benes herself and her school identified as education, and the like.

Further, the second chapter may describe Elaine Benes' ideology of feminism. Accordingly, the plurality of entities within the second chapter may be identified as Elaine Benes herself, feminism, politics, women, inequality, and the like, where the plurality of relationships may include a relationship between Elaine Benes herself and feminism identified as agreement ideology, a relationship between Elaine Benes herself and women identified as belong to, and the like.

It is noted here that the plurality of relationships may include relationships between entities identified from one of the plurality of data chunks and entities identified from another of the plurality of data chunks.

According to example embodiments, the plurality of entities and the plurality of relationships may be determined using the LLM.

Further, according to example embodiments, the plurality of entities and the plurality of relationships may be determined using the LLM and the prompting technique based on a third prompt.

According to example embodiments, the third prompt may specify a goal and a plurality of steps to determine the plurality of entities and the plurality of relationships to the LLM, where the LLM may perform operations in accordance with the prompt.

For example, the goal may specify “Given a text document that is potentially relevant to this activity and a list of entity types, identify all entities of those types from the text and all relationships among the identified entities. Use {language} as output language”.

Further, the plurality of steps may include “(1) Identify all entities. For each identified entity, extract the following information: entity_name: Name of the entity, use the same language as input text. If English, capitalize the name; entity_type: One of the following types: [{entity_types}]; entity_description: Comprehensive description of the entity's attributes and activities. Format each entity as (“entity”{tuple_delimiter}<entity_name>{tuple_delimiter}<entity_type>{tuple_delimiter}<entity_description>)”; “(2) From the entities identified in step 1, identify all pairs of (source_entity, target_entity) that are clearly related to each other. For each pair of related entities, extract the following information: source_entity: name of the source entity, as identified in step 1; target_entity: name of the target entity, as identified in step 1; relationship_description: explanation as to why you think the source entity and the target entity are related to each other; relationship_strength: a numeric score indicating the strength of the relationship between the source entity and target entity; relationship_keywords: one or more high-level key words that summarize the overarching nature of the relationship, focusing on concepts or themes rather than specific details. Format each relationship as (“relationship “{tuple_delimiter}<source_entity>{tuple_delimiter}<target_entity>{tuple_delimiter}<relationship_description>{tuple_delimiter}<relationship_keywords>{tuple_delimiter}<relationship_strength>)”; “(3) Identify high-level keywords that summarize the main concepts, themes, or topics of the entire text. These should capture the overarching ideas present in the document. Format the content-level keywords as (“content_keywords”{tuple_delimiter}<high_level_keywords>)”; “(4) Return output in {language} as a single list of all the entities and relationships identified in steps 1 and 2. Use **{record_delimiter}** as the list delimiter.”; and (5) When finished, output {completion_delimiter}”. The process then proceeds to operation S340.

At operation S340, the at least one processor may be configured and/or programmed to generate the knowledge graph. The knowledge graph may be generated based on the plurality of entities and the plurality of relationships of the plurality of data chunks.

In particular, the knowledge graph may include a plurality of graph nodes and a plurality of connections between the plurality of graph nodes, where the plurality of graph nodes may correspond to the plurality of entities determined from the plurality of data chunks during operation S330, and where the plurality of connections may correspond to the plurality of relationships determined from the plurality of data chunks during operation S330.

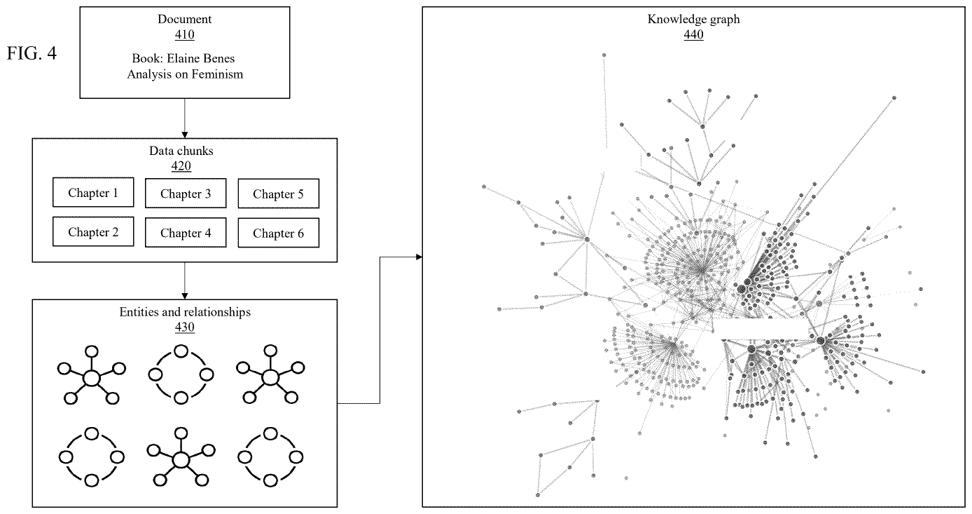

FIG. 4 illustrates an example visual representation of process 300, according to one or more example embodiments. As shown in FIG. 4, the process may involve segmenting the document 410 (e.g., the book “Elaine Benes Analysis on Feminism”) into a plurality of data chunks 420 (e.g., chapter 1 to chapter 6).

The process may then involve determining the plurality of entities and the plurality of relationships 430 for each of the plurality of data chunks 420. In the example shown in FIG. 4, the entities are shown as nodes (circles), while the relationships are shown as connections (lines/edges).

The process may then involve generating the knowledge graph 440 from the plurality of entities and the plurality of relationships 430. As shown in FIG. 4, the knowledge graph may include a plurality of graph nodes (circles) that are interconnected (lines/edges) with each other.

In certain implantation, the knowledge graph may be generated by combining the nodes and connections of each of the plurality of data chunks together.

Further, the knowledge graph may be generated based on the plurality of entities and the plurality of relationships from multiple documents. For example, another book “Elaine Benes Deep Dive Analysis” may be obtained, and operation S310 to operation S340 may be performed to generate another knowledge graph. Then the knowledge graph generated from the book “Elaine Benes Analysis on Feminism” and the knowledge graph generated from the book “Elaine Benes Deep Dive Analysis” may be combined together to form a single knowledge graph.

FIG. 5 illustrates a flow diagram of an example process 500 for performing graph-based RAG, according to one or more example embodiments. One or more operations of process 500 may be part of operation S130 in process 100, and may be performed by at least one processor (e.g., processor 1912) of the QP system.

As illustrated in FIG. 5, at operation S510, the at least one processor may be configured and/or programmed to select a plurality of seed nodes from the plurality of graph nodes.

In particular, as described above, the knowledge graph may include the plurality of graph nodes and the plurality of connections between the plurality of graph nodes. In this regard, the QP system may select the plurality of seed nodes from the plurality of graph nodes (e.g., select some nodes from all of the nodes in the knowledge graph, and the selected nodes here may be referred to as seed nodes).

According to example embodiments, the plurality of seed nodes may be selected based on relevance scores associated with the plurality of graph nodes. In particular, the relevance scores may indicate relevance between the plurality of graph nodes and the plurality of keywords (identified during operation S120 in process 200).

In this regard, according to example embodiments, the plurality of seed nodes may be selected based on relevance scores in accordance with a predefined criteria. For example, the plurality of graph nodes may include a first graph node having relevance score of 5 (indicating medium relevance to the plurality of keywords), a second graph node having relevance score of 1 (indicating low relevance to the plurality of keywords), a third graph node having relevance score of 9 (indicating very high relevance to the plurality of keywords), and a fourth graph node having relevance score of 7 (indicating high relevance to the plurality of keywords). In this regard, the predefined criteria may indicate selection of the top two graph nodes. Accordingly, the third graph node and the fourth graph node may be selected during operation S510, and may correspond to the plurality of seed nodes.

According to example embodiments, the at least one processor may be configured and/or programmed to select the plurality of seed nodes by: determining, for each graph node of the plurality of graph nodes, a relevance level between the respective graph node (e.g., the each graph node) to each of the plurality of keywords; identifying, for each of the plurality of graph nodes, a relevance level between the respective graph node (e.g., the each graph node) and a keyword of the plurality of keywords that is highest in comparison to other keywords of the plurality of keywords (e.g., a keyword associated with a highest relevance level from among a plurality of relevance levels associated with the plurality of keywords). According to embodiments, the relevance level between the respective graph node and a keyword of the plurality of keywords that is highest in comparison to other keywords of the plurality of keywords may correspond to the relevance score of the respective graph node. The at least one processor may be further configured and/or programmed to select the plurality of seed nodes by: selecting a number of graph nodes from the plurality of graph nodes having the relevance score higher than other graph nodes from the plurality of graph nodes, wherein the selected number of graph nodes may correspond to the plurality of seed nodes.

Examples of operations for selecting the plurality of seed nodes are described below with reference to FIG. 7. The process then proceeds to operation S520.

At operation S520, the at least one processor may be configured and/or programmed to select, for each of the plurality of seed nodes, a plurality of flow-selected nodes from the plurality of graph nodes having connections to the respective seed node.

In particular, for example, the third graph node and the fourth graph node may be selected during operation S510 and may correspond to the plurality of seed node. Then, during operation S520, the QP system may select a plurality of flow-selected nodes from the plurality of graph nodes that is connected to the third graph node, and select a plurality of flow-selected nodes from the plurality of graph nodes that is connected to the fourth graph node.

The connection here in operation S520 may correspond to any level-connection (e.g., direct connection, second degree connection through one intermediate node, third degree connection through two intermediate nodes, and the like).

According to example embodiments, the plurality of flow-selected nodes may be selected using a flow diffusion process. In this regard, according to example embodiments, the plurality of flow-selected nodes may be selected using the flow diffusion process in combination with iterative mass redistribution under push-relabel algorithm.

According to example embodiments, the flow diffusion process may include a selection method following a fluid flow concept in physics, wherein a starting node is injected with a mass of a particular quantity. Once the mass is injected into the starting node, the mass may flow (diffuse) from the starting node to a number of nodes connected to the starting node. In this regard, the connections between the starting node and the number nodes connected to the starting node may have an associated weight. Accordingly, the mass may flow (diffuse) from the starting node to different nodes differently based on the associated weights. In this regard, for a connection to a node that has a low weight, the mass may not flow from the starting node to said node. On the other hand, for a connection to a node that has a high weight, the mass may flow from the starting node to said node. It is understood that the mass may flow to one or more nodes. Further, once the mass has flow to a particular node connected to the starting node, the mass may further flow to more nodes connected to that particular node.

The diffusion of the mass from the starting node to the number of nodes may be determined based on various parameters, such as the initial quantity of mass, weights associated with various connections, capacity of the nodes to hold mass before flowing to another (overflowing), and the like. The nodes which the mass flows to may correspond to selection.

In other words, the flow diffusion process may describe the process of spreading mass from one or more seed nodes to neighboring nodes along edges of a graph. The empirical and theoretical performance of local diffusion processes may typically be evaluated in the context of local graph clustering.

According to example embodiments, the at least one processor may be configured and/or programmed to select the plurality of flow-selected nodes by, for each of the plurality of seed nodes: identifying a plurality of connected nodes directly connected to the respective seed node; determining a plurality of weights associated with the plurality of connected nodes based on relevance levels between the plurality of connected nodes and the respective seed node, a relevance level between the respective seed node and the query, and relevance levels between the plurality of connected nodes and the query; and selecting one or more of the plurality of connected nodes based on the plurality of weights associated with the plurality of connected nodes and a source mass injection value.

Further, according to example embodiments, the at least one processor may be further configured and/or programmed to select the plurality of flow-selected nodes by, for each selected connected node from among the selected one or more connected nodes from among the plurality of connected nodes: determining a sink capacity value associated with the respective selected connected node (e.g., associated with the each selected connected node); identifying a plurality of sub-connected nodes directly connected to the respective selected connected node; determining a plurality of weights associated with the plurality of sub-connected nodes based on relevance levels between the plurality of sub-connected nodes and the respective selected connected node, a relevance level between the respective selected connected node and the query, and relevance levels between the plurality of sub-connected nodes and the query; and selecting one or more of the plurality of sub-connected nodes based on the plurality of weights associated with the plurality of sub-connected nodes, the source mass injection value, and the sink capacity value associated with the respective selected connected node.

Examples of operations for selecting the plurality of flow-selected nodes are described below with reference to FIG. 9.

In this regard, the plurality of seed nodes selected during operation S510, the plurality of flow-selected nodes selected during operation S520, and connections connecting the plurality of seed nodes and the plurality of flow-selected nodes to each other may form the plurality of sub-graphs. For example, a first seed node and a first plurality of flow-selected nodes connected to the first seed node may form a first sub-graph, a second seed node and a second plurality of flow-selected nodes connected to the second seed node may form a second sub-graph, and the like.

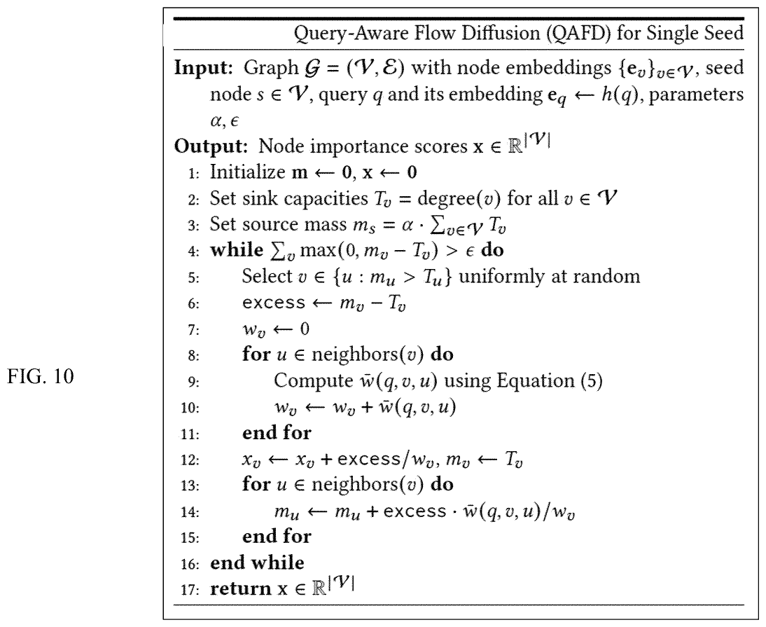

According to example embodiments, the seed node and flow-selected node selection using the flow diffusion process may compute the semantic similarity between query keywords and graph entities using pre-trained embeddings. For each entity v, a relevance score may be calculated as the maximum similarity across all query keywords, then select the top-N highest-scoring entities as seed nodes. Mass may then be injected at these seed nodes and perform flow diffusion with query-aware edge weights that combine structural similarity and query relevance. The process may solve a constrained optimization problem (equation (11) below) using a push-relabel algorithm (algorithm shown in FIG. 10 described below) that iteratively redistributes excess mass while maintaining conservation constraints, yielding node importance scores that indicate entity relevance to the query.

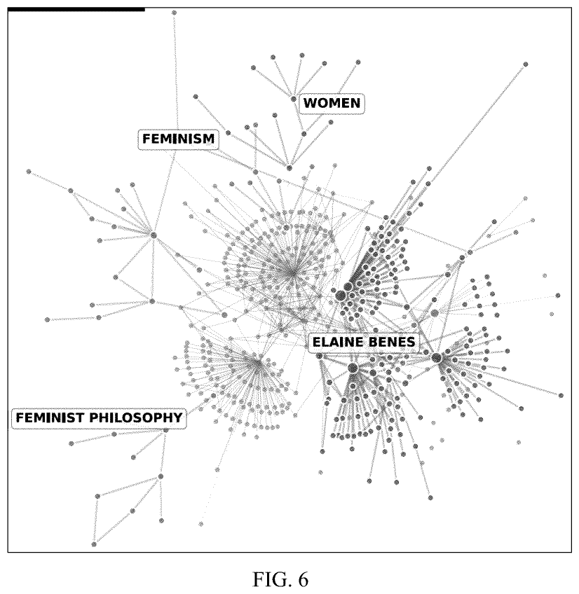

FIG. 6 illustrates an example knowledge graph containing a plurality of subgraphs, according to one or more example embodiments.

In the example shown in FIG. 6, nodes representing the entities “Elaine Benes”, “feminism”, “women”, and “feminist philosophy” in the plurality of graph nodes may have the highest relevance score in comparison to other graph nodes (e.g., highest relevance to the plurality of keywords “feminism”, “philosophy”, “character evaluation”, “Elaine Benes”, “book analysis”, “gender roles”, and “social commentary” of the query “What role does feminism play in the book's analysis of Elaine Benes?” identified during operation S120 in process 200).

Accordingly, based on a predefined criteria indicating selection of top four graph nodes, said nodes representing the entities “Elaine Benes”, “feminism”, “women”, and “feminist philosophy” may be selected during operation S510, and may correspond to the plurality of seed nodes.

Subsequently, using the flow diffusion process, a plurality of flow-selected nodes may be selected for each of the seed nodes “Elaine Benes”, “feminism”, “women”, and “feminist philosophy”. For example, FIG. 6 shows the plurality of flow-selected nodes connected to the seed node “Elaine Benes” in the darkest shade, forming one sub-graph in the knowledge graph. The following provide descriptions associated with the process 500.

According to example embodiments, process 500 may be performed to perform the graph-based RAG in order to identify the plurality of sub-graphs from the knowledge graph. The sub-graph identification (retrieval) problem may be formulated, and reduced to an efficiently solvable query-aware flow diffusion process.

Here, the query (e.g., natural language query obtained during operation S110 in process 100) may be represented by q∈ [symbol] . The knowledge graph may be represented by [symbol] =( [symbol] , ε, [symbol] ), where [symbol] may represent the entities in the knowledge graph (e.g., plurality of graph nodes), E may represent the relationships between the entities in the knowledge graph (e.g., plurality of connections between the plurality of graph nodes), and [symbol] may represent a set of relations.

The goal of process 500 may be to retrieve and identify a query-relevant sub-graph that captures the most important reasoning paths, which may be used downstream for language model processing (e.g., during operation S140 in process 100). The query-relevant sub-graph may be represented as [symbol] _{q}=( [symbol] _{q}, ε_{q})⊆ [symbol] .

In view of the above, the sub-graph identification (retrieval) problem may be formulated according to the following expression.

$${𝒢}_{q}^{*} = {arg max}_{{𝒢}_{q} ⊆ 𝒢} U ( q , {𝒢}_{q} ) \qquad ( 1 )$$

Here, U may be defined as U: [symbol] × [symbol] →Realnumber, and may represent a measurement of the utility of sub-graph [symbol] _{q} for providing a response (e.g., answering) the query q through semantic alignment between the query and the reasoning paths contained in the subgraph.

Here, the core computational challenge associated with equation (1) may lie in the exponential search space over all possible sub-graphs in the knowledge graph, which may scale as O( [symbol] ^{+|ε|}). To address this intractability, the retrieval process may be decomposed into two sequential stages. First, relevant seed entities Sᵥ⊆ [symbol] may be identified as described above in operation S510 and below in process 700, which may serve as diffusion sources based on semantic similarity with query keywords. Second, query-aware signals may be propagated from these seed entities through the knowledge graph structure to discover semantically coherent reasoning paths as described above in operation S520 and below in process 900.

This decomposition may be justified by the locality assumption that the most relevant reasoning paths for query q are concentrated within bounded neighborhoods of a small set of semantically relevant seed entities.

FIG. 7 illustrates a flow diagram of an example process 700 for selecting a plurality of seed nodes, according to one or more example embodiments. One or more operations of process 700 may be part of operation S510 in process 500, and may be performed by at least one processor (e.g., processor 1912) of the QP system.

Here, the identification of the plurality of seed nodes may enable identification of entities most relevant to the query as starting points for the flow diffusion process to be performed as described below in process 900. In this regard, a semantic similarity-based approach that assumes the utility contribution of individual seed entities is approximately additive may be employed, enabling independent scoring of candidate seeds.

As illustrated in FIG. 7, at operation S710, the at least one processor may be configured and/or programmed to determine, for each of the plurality of graph nodes, a relevance level between the respective graph node to each of the plurality of keywords.

For example, the plurality of keywords may include a first keyword, a second keyword, and a third keyword. In this regard, the QP system may determine, for each of the plurality of graph nodes, a relevance level between the respective graph node and the first keyword, a relevance level between the respective graph node and the second keyword, and a relevance level between the respective graph node and the third keyword.

According to example embodiments, the relevance level between the respective graph node to each of the plurality of keywords may be determined using the LLM in accordance with a prompt under the prompting technique. It is understood that the relevance level may be defined in any form, such as discrete levels, and the like.

In particular, according to example embodiments, a keyword extraction function, which maps the query q to the plurality of keyword [symbol] _{q}={w₁, w₂, . . . , [symbol] }, may be defined as g: [symbol] → [symbol] . Here, [symbol] may represent the vocabulary space.

Further, a textual identifiers associated with the plurality of graph nodes in the knowledge graph [symbol] may be defined as [symbol] ={ [symbol] ᵥ: v∈ [symbol] )}, where [symbol] ᵥ may represent a string representation of node v (e.g., entity name, URL, label, etc.)

Furthermore, a semantic embedding function that maps both keywords and node identifiers to a d-dimensional embedding space may be defined as h: [symbol] ∩ [symbol] → [symbol] ^{d}. In this regard, the semantic embedding function may map the keywords and the node identifiers to the d-dimensional embedding space using pre-trained encoders, defined according to the following expressions.

$${ε}_{q} = {\{ h ( {w}_{i} ) \}}_{i = 1}^{\vert {𝒦}_{q} \vert} = {\{ {e}_{q , i} ∈ {ℝ}^{d} \}}_{i = 1}^{\vert {𝒦}_{q} \vert} \qquad ( 2 )$$

$${ε}_{V} = {\{ h ( {k}_{v} ) \}}_{v ∈ V} = {\{ {e}_{v} ∈ {ℝ}^{d} \}}_{v ∈ 𝒱} \qquad ( 3 )$$

In this regard, a similarity function that measures the semantic relatedness/relevancy between embedding may be defined as Hₛᵢₘ= [symbol] ^{d}× [symbol] ^{d}→ [symbol] . The similarity function can be instantiated as cosine similarity as shown below in expression (4), dot product below in expression (5), or radial basis function (RBF) kernel as shown in below in expression (6).

$$\frac{e \cdot {e}^{′}}{{‖ e ‖}_{2} {‖ {e}^{′} ‖}_{2}} \qquad ( 4 )$$

$$e \cdot {e}^{′} \qquad ( 5 )$$

$$exp ( - γ {‖ e - {e}^{′} ‖}_{2}^{2} ) \qquad ( 6 )$$

In expression (6) above, γ>0 represents a constant. In view of the above, the relevance level between the respective graph node to each of the plurality of keywords may be determined using the similarity function in accordance with the following expression.

Relevanceₑ_{_{q,i}}ₑ_{ᵥ}=Hₛᵢₘ(e_{q,i},eᵥ) (7)

The process then proceeds to operation S720.

At operation S720, the at least one processor may be configured and/or programmed to identify, for each of the plurality of graph nodes, a relevance level between the respective graph node to a keyword of the plurality of keywords that is highest in comparison to other keywords of the plurality of keywords.

Here, the relevance level between the respective graph node to a keyword of the plurality of keywords that is highest in comparison to other keywords of the plurality of keywords may correspond to the relevance score of the respective graph node.

For example, the QP system may determine that, for a first graph node of the plurality of graph nodes, the relevance level between the first graph node and the first keyword is 5, the relevance level between the first graph node and the second keyword is 9, and the relevance level between the first graph node and the third keyword is 2 during operation S710. Subsequently, during operation S720, the QP system may identify that the relevance level between the first graph node and the second keyword 9 is the highest in comparison to other keywords (5 with the first keyword and 2 with the third keyword). Accordingly, the relevance level 9 may be identified as the relevance level between the first graph node to a keyword of the plurality of keywords that is highest in comparison to other keywords of the plurality of keywords, and may correspond to the relevance score of the first graph node. The above may be performed for each of the plurality of graph nodes.

In particular, based on equation (7), the relevance score of node v with respect to query q, may be defined as the maximum similarity across all of the plurality of keywords, according to the following expression.

$$Relevance Score ( v , q ) = {max}_{i = 1 , … , \vert {𝒦}_{q} \vert} {H}_{s i m} ( {e}_{q , i} , {e}_{v} ) \qquad ( 8 )$$

The process then proceeds to operation S730.

At operation S730, the at least one processor may be configured and/or programmed to select a number of graph nodes from the plurality of graph nodes having the relevance score higher than other graph nodes from the plurality of graph nodes.

Here, the selected number of graph nodes in operation S730 may correspond to the plurality of seed nodes.

In this regard, according to example embodiments, the number of graph nodes may be selected in accordance with the predefined criteria (e.g., top two graph nodes).

In particular, according to example embodiments, the predefined criteria may specify selection of top-N number of nodes, where N entities may be selected with the highest relevance score. In this regard, the Nth largest value in a set of all relevance scores may be represented as s^{(N)}. Accordingly, the section of the N entities with the highest relevance score may be performed in accordance with the following expression.

[symbol]

={v∈ [symbol] :Relevance Score (v,q)≥s^{(N)}}∩{v₁,v₂, . . . ,v_{N}} (9)

Here, {v₁, v₂, . . . , v_{N}} may represent N entities from {v∈V:Relevance Score (v, q)≥s^{(N)}}.

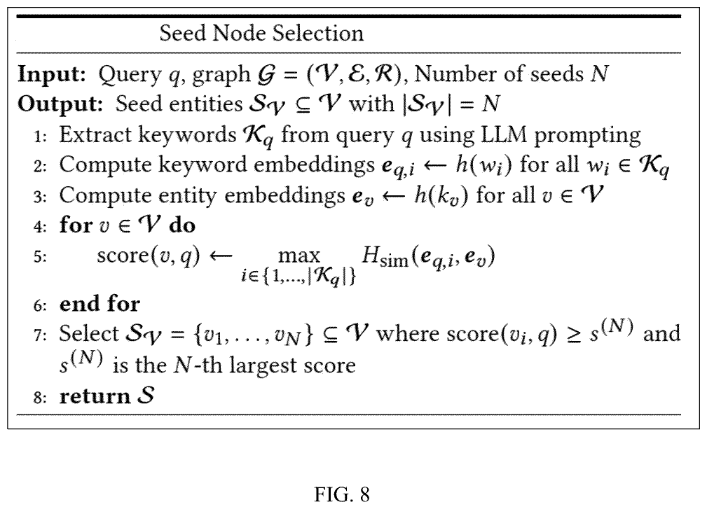

FIG. 8 illustrates an example algorithm for selecting a plurality of seed nodes, according to one or more example embodiments.

It is noted here that the algorithm shown in FIG. 8 may involve polynomial-time complexity O(| [symbol] |· [symbol] _{q}|·d+| [symbol] |log N), where the first term accounts for similarity computations and the second for the top-N selection.

FIG. 9 illustrates a flow diagram of an example process 900 for selecting a plurality of flow-selected nodes, according to one or more example embodiments. One or more operations of process 900 may be part of operation S520 in process 500, and may be performed by at least one processor (e.g., processor 1912) of the QP system.

According to example embodiments, process 900 may involve the flow diffusion process in combination with iterative mass redistribution under a push-relabel algorithm.

As illustrated in FIG. 9, at operation S910, the at least one processor may be configured and/or programmed to determine an initial distribution of a plurality of source mass values. In embodiments, the initial distribution may represent an initial amount of mass that may be injected into the plurality of seed nodes. For example, operation S910 may include determining the initial distribution by determining a source mass value corresponding to each seed node of the plurality of seed nodes (e.g., a value representing an amount of mass that is initially injecting into each seed node).

At operation S920, the at least one processor may be configured and/or programmed to perform an iterative propagation process to redistribute the plurality of source mass values through the knowledge graph. In embodiments, the iterative propagation process may correspond to the iterative mass redistribution under push-relabel algorithm discussed above.

In embodiments, the plurality of source mass values may be redistributed based on a plurality of query-aware edge weights that may be computed based on relevance levels between connected nodes and relevance levels between the connected nodes and the query.

For example, returning to the example in FIG. 2 and FIG. 6, for graph node 208 representing the entity “Feminism” (seed node), the QP system may identify graph node 206, graph node 207, graph node 209, graph node 210, and graph node 215 as the plurality of connected nodes directly connected to graph node 208. Similarly, for graph node 202 representing the entity “Women” (seed node), the QP system may identify graph node 206, graph node 201, graph node 203, and graph node 215 as the plurality of connected nodes directly connected to graph node 202. The process then proceeds to operation S920.

determine, for each of the plurality of seed nodes, a plurality of weights associated with the plurality of connected nodes. In embodiments, the plurality of weights may correspond to the plurality of query-aware edge weights. The plurality of weights may be determined based on relevance levels between the plurality of connected nodes and the respective seed node, a relevance level between the respective seed node and the query, and relevance levels between the plurality of connected nodes and the query.

In particular, for example, for a first seed node of the plurality of seed nodes, the QP system may determine a weight associated with a first connected node of the plurality of connected nodes based on a relevance level between the first connected node and the first seed node, a relevance level between the first seed node and the query, and a relevance level between the first connected node and the query. Similarly, the QP system may also determine a weight associated with a second connected node of the plurality of connected nodes based on a relevance level between the second connected node and the first seed node, a relevance level between the first seed node and the query, and a relevance level between the second connected node and the query. The above may be performed for each of the plurality of connected nodes and each of the plurality of seed nodes.

Here, it is understood that, by incorporating the relevance levels between the plurality of connected nodes and the respective seed node, the relevance level between the respective seed node and the query, and the relevance levels between the plurality of connected nodes and the query into the determination of the weight, query semantics may be incorporated directly into the diffusion process through dynamic edge reweighting.

In particular, according to example embodiments, query-aware flow diffusion may be performed based on seed entities [symbol] and query q to discover relevant reasoning subgraphs.

In this regard, query aware edge weights associated with the plurality of connected nodes (or with the connections/edges connecting the plurality of connected nodes to the seed node) may be determined according to the following expression, given query q and connection (edge) between two nodes (u, v).

\tilde{w}(q,u,v)=Hₛᵢₘ(h(u),h(v))·Hₛᵢₘ(h(u),h(q))·Hₛᵢₘ(h(v),h(q)) (10)

Here, h(·) may represent an embedding function that maps entities and queries to a common vector space. Hₛᵢₘ(h(u), h(v)) may represent the structural similarity between two nodes (e.g., relevance level between the first connected node and the first seed node). Hₛᵢₘ(h(u), h(q)) may represent the structural similarity between a node (e.g., connected node) and the query (relevance level between the first connected node and the query). Hₛᵢₘ(h(v), h(q)) may represent the structural similarity between another node (e.g., seed node) and the query (relevance level between the first seed node and the query). It is also noted here that operator (·) in equation 10 above may denote a generic binary operation, such as (×), (+), and the like.

The above process may enable adaptive construction of query-specific graphs that emphasize both local connectivity and query relevance. Importantly, the above plurality of weights may be computed on-demand: when a query arrives, the query embedding may first be computed, then edge weights may be calculate only for nodes encountered during traversal (those connecting to the current node). In experiments conducted, it is observed that when the first operation is multiplication and the second is summation, empirical results may be obtained. The process then proceeds to operation S930.

At operation S930, the at least one processor may be configured and/or programmed to compute a plurality of importance scores based on the redistributed plurality of source mass values. In embodiments, the plurality of importance scores may correspond to the node importance scores discussed above.

At operation S940, the at least one processor may be configured and/or programmed to select the plurality of flow-selected nodes based on a comparison between the plurality of importance scores and a predetermined threshold score. For example, a graph node may be selected to be included in the plurality of flow-selected nodes based on determining that an importance score corresponding to the graph node is greater than the predetermined threshold score.

In particular, as described above, according to example embodiments, the flow diffusion process may include a selection process, wherein a starting node is injected with a mass of a particular quantity (which may be referred to as a source mass injection value, and which may be included in the initial distribution of the plurality of source mass values). The starting node here may refer to the seed node. Once the mass is injected into the starting node, the mass may flow (diffuse) from the starting node to a number of nodes connected to the starting node. The number of nodes connected to the starting node here may refer to the plurality of connected nodes directly connected to the seed node. In this regard, the connections between the starting node and the number nodes connected to the starting node may have an associated weight (e.g., the plurality of weights determined during operation S920).

Accordingly, the mass may flow (diffuse) from the starting node to a different nodes differently based on the associated weight. In this regard, for a connection to a node that has a low weight, the mass may not flow from the starting node to said node. On the other hand, for a connection to a node that has a high weight, the mass may flow from the starting node to said node. It is understood that the mass may flow to one or more nodes.

In view of the above, based the plurality of weights and source mass injection value under the flow diffusion process, for each of the plurality of seed nodes, the QP system may inject mass to the respective seed node and identify which of the plurality of connected nodes directly connected to the respective seed node the mass flows to. Accordingly, the QP system may select the connected node which the mass flows to during operation S920.

For example, returning to FIG. 2 and FIG. 6, for graph node 208 representing the entity “Feminism” (seed node), the QP system may identify graph node 206, graph node 207, graph node 209, graph node 210, and graph node 215 as the plurality of connected nodes directly connected to graph node 208. In this regard, based the plurality of weights associated with graph node 206, graph node 207, graph node 209, graph node 210, and graph node 215 and source mass injection value of the mass injected to graph node 208 under the flow diffusion process, the mass may flow from graph node 208 to graph node 206, graph node 215, and graph node 210. Accordingly, the QP system may identify that graph node 206, graph node 215, and graph node 210 are the nodes which the mass flows to, and select said nodes during operation S930. The above may be performed for each of the seed nodes.

In particular, according to example embodiments, the flow diffusion process may be formulated as a constrained optimization problem that balances minimizing the total flow cost while satisfying mass conservation constraints at each node. In this regard, the flow diffusion process may be expressed according to the following expression.

$${min}_{f ∈ {ℝ}^{\vert ε \vert}} \frac{1}{2} {f}^{T} \tilde{W} ( q ) f subject to Δ + B \tilde{W} ( q ) f \leq T \qquad ( 11 )$$

Here, ƒ∈ [symbol] ^{|ε|} may represent flow value on connections/edges. \tilde{W}(q)∈ [symbol] ^{|ε|} may represent diagonal matrix of query aware edge weight (e.g., \tilde{w}). B∈ [symbol] ^{|V|×|ε|} may represent incidence matrix of [symbol] . T∈ [symbol] may represent sink capacities. Δ∈ [symbol] may represent a source vector, which may encode source mass injection. Further, the source vector may be defined according to the below expression.

Δᵥ=α [symbol] Tᵤ (12)

Here, the source vector may control the initial mass distribution across nodes, with a common choice as shown in equation (12) above for source node (seed node) v∈ [symbol] and Δᵥ=0 otherwise, where parameter a may control the source strength.

It is understood that, in certain implementation, the mass may not flow to any of the plurality of connected nodes directly connected to a particular seed node (e.g., all the weights are very low). In such case, the QP system may not select any of the plurality of connected nodes directly connected to such particular seed node. In this regard, in certain implementation, the mass may not flow to any of the plurality of connected nodes directly connected to any of the plurality of seed nodes. In such case, the process may end, where there are no plurality of flow-selected nodes, and the plurality of sub-graphs may be formed from only the plurality of seed nodes and connections connecting the plurality of seed nodes with each other (if any).

In embodiments, the iterative propagation process of operation S920 may include determining a sink capacity value corresponding to each graph node knowledge graph (or each of at least some of the graph nodes) based on a degree of the graph node.

In particular, as described above, according to example embodiments under the flow diffusion process, once the mass has flow from a starting node (seed node) to a particular node connected to the starting node, the mass may further flow to more nodes connected to that particular node. Here, the node connected to the starting node which the mass flows to may correspond to the selected one or more of the plurality of connected nodes. In this regard, the sink capacity value may specify how much mass a particular node can hold before the mass diffuses to more node.

According to example embodiments, the sink capacity value may be determined according to degree-based capacity, where Tᵥ=degree (v). Under the degree-based capacity, the sink capacity value of different nodes may be different based on the respective degree, where high-degree nodes may accumulate more mass proportional to their connectivity.

According to example embodiments, the sink capacity value may be determined according to uniform capacity, where Tᵥ=β, and where β is a constant greater than zero. Under the uniform capacity, the sink capacity value of different nodes may be the same degree, where all nodes may be treated equally regardless of their structural prominence.

Accordingly, the sink capacity value associated with the respective selected connected node may be determined according to the above. In embodiments, the iterative propagation process of operation S920 may further include determining whether an accumulated source mass value associated with the each graph node is greater than the sink capacity value;

In embodiments, the iterative propagation process of operation S920 may further include, based on determining that the accumulated source mass value is greater than the sink capacity value, computing at least one query-aware edge weight corresponding to at least one neighboring node based on a relevance level between the each identified graph node and the at least one neighboring node, a relevance level between the each identified graph node and the query, and a relevance level between the at least one neighboring node and the query.

In embodiments, the iterative propagation process of operation S920 may further include distributing an excess mass value to the at least one neighboring node proportionally according to the at least one query-aware edge weight, and

In embodiments, the iterative propagation process of operation S920 may be repeated until a total excess mass value is less than a convergence threshold value.

Accordingly, the selected one or more of the plurality of connected nodes, the selected one or more of the plurality of sub-connected nodes, and any subsequent selected nodes, may correspond to the plurality of flow-selected nodes.

In other words, the operations described above in relation to process 500, 700 and 900 under the flow diffusion process may involve traversal of the knowledge graph. In particular, the process may start at the seed nodes and traverse through various nodes in the knowledge graph from the seed nodes following the flow of the mass, forming various branches that correspond to sub-graphs as shown in FIG. 6.

The following provide additional descriptions associated with the flow diffusion process.

With the above defined sink capacity and source vector expressions, it may be more convenient to consider a dual problem of equation (11), where the sink capacity T and source vector Δ may be brought in as constraints to the objective. In particular, from equation (11), a Lagrangian function with multiplier vector x∈

$${ℝ}_{+}^{\vert ν \vert}$$

may be defined according to the following expression.

$$L ( f , x ; q ) = \frac{1}{2} {f}^{T} \tilde{W} ( q ) f + {x}^{T} ( Δ + B \tilde{W} ( q ) f - T ) \qquad ( 13 )$$

Then, taking partial derivative with respect to f and setting it to zero yields the primal-dual relationship ƒ=−Bx. Substituting this back into the Lagrangian equation (13) may provide the following expression.

$$L ( x ; q ) = \frac{1}{2} - B {x}^{T} \tilde{W} ( q ) ( - B x ) + {x}^{T} ( Δ + B \tilde{W} ( q ) ( - B x ) - T ) \qquad ( 14 )$$

For notational simplicity, the implicit dependence on f in the objective definition may be omitted. After algebraic manipulation and setting the weighted Laplacian L(q)=B\tilde{W}(q)B^{T}, the dual problem may be expressed according to the following expression.

$${min}_{x ∈ {ℝ}_{+}^{\vert ν \vert}} F ( x ; q ) = \frac{1}{2} {x}^{T} L ( q ) x + {x}^{T} ( T - Δ ) \qquad ( 15 )$$

Accordingly, the solution to equation (15) may yield node importance scores x∈ [symbol] indicating the relevance of each entity to the query.

FIG. 10 illustrates an example algorithm for selecting a plurality of flow-selected nodes of a particular seed node, according to one or more example embodiments. According to example embodiment, the algorithm shown in FIG. 10 may correspond to operations described above in relation to process 500, 700, and 900.

Here, the algorithm shown in FIG. 10 may involve coordinate-wise updates on the dual objective shown in equation (15) for the given query and single seed node. For simplicity, the initial mass A may be removed by choice Δᵥ=αΣ_{u∈V}Tᵤ for source node (seed node) v∈ [symbol] and Δᵥ=0 otherwise.

At each iteration, the algorithm may involve randomly selecting a node v from the set of nodes with excess mass (e.g., nodes which mᵥ>Tᵥ) and increases xᵥ to reduce the objective function. The mass vector m may serve as an efficient tracker of the gradient of F(x).

In this regard, the algorithm shown in FIG. 10 may involve two parts: initialization and traversal.

Regarding the initialization, the algorithm may involve initialization of query-aware flow diffusion RAG, according to one or more example embodiments. Initially, m=Δ which may represent negative gradient at x=0. As the algorithm updates x, it may simultaneously update m to reflect the current gradient. At initialization, x=0 and m=Δ, so the initial gradient may correspond to ∇F(0)=T−Δ. The negative gradient direction may correspond to −∇F(0)=Δ−T and may provide the steepest descent direction.

More generally, the mass vector may be maintained as m=Δ+B\acute{W}(q)B^{T} where ƒ=−Bx by the primal-dual relationship. Substituting this relationship may provide m=A+L(q)x, which may directly link to the gradient, according to the following expression.

∇F(x,q)=L(q)x+(T−A)=T−m (16)

Here, the key condition mᵥ>Tᵥ mentioned above may be equivalent to ∂F/∂xᵥ<0, which may confirm that increasing xᵥ decreases the objective function. The algorithm's push operations may maintain complementary slackness: active constraints (xᵥ>0) may correspond to nodes exactly at their capacity (mᵥ=Tᵥ), satisfying the dual optimality conditions.

Regarding the traversal, the algorithm may involve locality properties and online traversal, according to one or more example embodiments. After obtaining the source nodes (seed nodes) [symbol] , the algorithm shown in FIG. 2 may maintain the locality nature of flow diffusion while enabling online graph traversal. The locality property may be particularly crucial for large-scale knowledge graphs where the number of entities and relationships can reach millions.

Unlike graph-based RAG of the related art that may require complete preprocessing of the entire knowledge graph, the query-aware flow diffusion graph-based RAG according to one or more example embodiments of the present disclosure may dynamically discover relevant entities and relationships during traversal.

In particular, when mass flows from node v to its neighbors, the algorithm may: compute query-aware edge weights \tilde{w}(q, u, v) as described above in equation (10) as edges/connections are encountered; retrieve embeddings eᵤ and entity properties only when mass propagates to node u; and determine sink capacities Tᵤ dynamically based on the node's role. This evaluation may ensure complexity scales with the explored subgraph size rather than the entire knowledge graph, enabling scalability to enterprise knowledge bases with millions of entities.

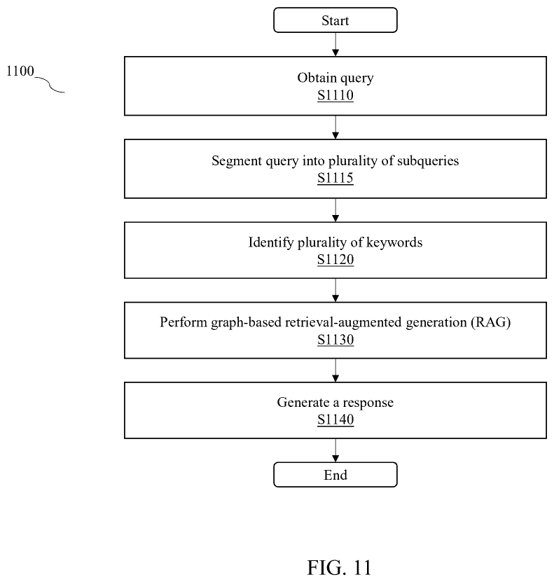

FIG. 11 illustrates a flow diagram of an example process 1100 for enhancing RAG, according to one or more example embodiments. One or more operations in process 1100 may be performed by at least one processor (e.g., processor 1912) of the QP system.

As shown in FIG. 11, one or more operations in process 1100 may be similar to one or more operations in process 100 in FIG. 1. Thus, similar descriptions are omitted for conciseness.

As illustrated in FIG. 11, at operation S1110, the at least one processor may be configured and/or programmed to obtain a query, in the similar manner as operation S110 in process 100. The process then proceeds to operation S1115.

At operation S1115, the at least one processor may be configured and/or programmed to segment the query into a plurality of subqueries.

For example, the query may include “Please help me find the film category with the highest total rental hours in cities whose names either start with ‘A’ or contain a hyphen”.

In this regard, the query may be segmented into the plurality of subqueries including, for example, a first subquery including filtering cities having names either start with ‘A’ or contain a hyphen, a second subquery including connecting cities to addresses and customers, a third subquery including finding film rentals by these customers, a fourth subquery including linking rentals to films to compute rental hours, and a fifth subquery including determining the film categories with the highest total rental hours.

According to example embodiments, the query may be segmented into the plurality of subqueries using the LLM. More specifically, the query may be segmented into the plurality of subqueries using LLM-based decomposition. The process then proceeds to operation S1120

At operation S1120, the at least one processor may be configured and/or programmed to identify multiple pluralities of keywords associated with the query, in the similar manner as described above in relation to operation S120 in process 100.

For example, during operation S1120, keyword “cities” may be identified for the first subquery; keywords “cities”, “addresses”, and “customers” may be identified for the second subquery; keywords “film rentals” and “customers” may be identified for the third subquery; keywords “films” and “rentals” may be identified for the fourth subquery; and keywords “film categories” and “rentals” may be identified for the fifth subquery. The process then proceeds to operation S1130.

At operation S1130, the at least one processor may be configured and/or programmed to perform graph-based RAG. The graph-based RAG may be performed based on the plurality of keywords in order to identify multiple pluralities of sub-graphs from the knowledge graph relevant to the plurality of subqueries.

In particular, for example, the at least one processor may be configured and/or programmed to identify a first plurality of sub-graphs relevant to a first subquery, identify a second plurality of sub-graphs relevant to a second subquery, and the like.

In this regard, the at least one processor may be configured and/or programmed to perform the graph-based RAG to identify multiple pluralities of sub-graphs relevant to the plurality of subqueries individually, in the similar manner as described above in relation to operation S130 in process 100. The process then proceeds to operation S1140.

At operation S1140, the at least one processor may be configured and/or programmed to generate a response to the query based on an aggregation of the multiple pluralities of sub-graphs.

In particular, according to example embodiments, the multiple pluralities of sub-graphs may be aggregated into a single plurality of sub-graphs relevant to the query, where the QP system may generate the response to the query based on the single plurality of sub-graphs, in the similar manner as described above in relation to operation S140 in process 100.

The following provide additional descriptions associated with the flow diffusion process performed with the plurality of subqueries.

Given a complex query q, the QP system may segment/decompose the query into K subqueries {q₁, q₂, . . . , q_{K}} using the LLM-based decomposition, where each subquery qᵢ may capture a specific reasoning aspect of the original query. This decomposition enable application of the flow diffusion process to each subquery independently.

In particular, for each subquery q_{K}, the independent processing may be performed by applying the algorithm shown in FIG. 8 to obtain seed set [symbol] , where subquery-specific edge weights may be determined according to the following expression.

\tilde{w}(qₖ,u,v)=Hₛᵢₘ(h(u),h(v))·Hₛᵢₘ(h(u),h(qₖ))·Hₛᵢₘ(h(v),h(qₖ)) (17)

The process may then involve solving the flow optimization problem for each subquery. Specifically, following the dual formulation in equation (15), the following expression may be obtained.

$${min}_{{x}^{k} ∈ {ℝ}_{+}^{\vert ν \vert}} F ( {x}^{( k )} ; q ) = \frac{1}{2} {( {x}^{( k )} )}^{T} {L}^{( k )} ( {q}_{k} ) {x}^{( k )} + {( {x}^{( k )} )}^{T} ( {T}^{( k )} - {Δ}^{( k )} ) \qquad ( 18 )$$

Here, L^{(k)}(qₖ)=B\tilde{W}^{(k)}(qₖ)B^{T} may represent the weighted Laplacian matrix for subquery qₖ, where \tilde{W}^{(k)}(qₖ) may represent the diagonal matrix of subquery-specific edge weights \tilde{w}(qₖ, u, v).

In this regard, the solution may yield subquery-specific node importance scores x^{(k)}, and the support set for subquery qₖ may be defined according to the following expression.

$${v}_{sup port}^{( k )} = \{ v ∈ V : {x}_{v}^{( k )} \geq \underline{ϵ} \} \qquad ( 19 )$$

Here, ∈>0 may represent a small threshold to filter out negligible flow values. The final retrieved subgraph may combine information from all subqueries according to the following expression.

$${𝒢}_{q} = {⋃}_{k = 1}^{K} {𝒢}_{qk} \qquad ( 20 )$$

Here, each [symbol] _{gk} may be constructed from the support set

$${v}_{support}^{( k )}$$

and the corresponding edges/connections.

Upon performing operation S1140, the process 1100 may be ended or be terminated. Alternatively, process 1100 may return to operation S1110, such that the at least one processor may be configured and/or programmed to repeatedly perform, for at least a predetermined amount of time, the obtaining the query (at operation S1110), the segmenting the query (at operation S1115), the identifying the plurality of keywords (at operation S1120), the performing the graph-based RAG (at operation S1130), and the generating the response (at operation S1140).

In view of the above, the above processes may provide an effective means to process queries containing complex multi-hop reasoning aspects.

The decomposition of the query into the plurality of subqueries may allow the embedding of each subquery to be captured more effectively during traversal of the knowledge graph (described below) and handle each reasoning aspect independently before aggregating the results.

In other words, example embodiments of the present disclosure may be extended to handle multiple subqueries by leveraging the insight that complex queries often involve multiple reasoning aspects that can be addressed independently and then combined to provide comprehensive coverage.

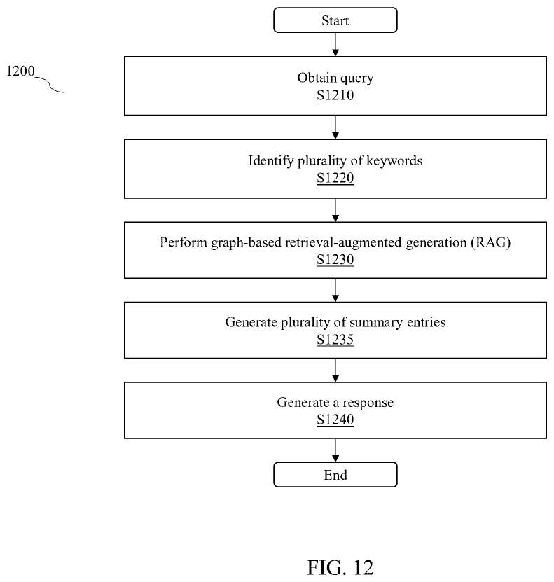

FIG. 12 illustrates a flow diagram of an example process 1200 for enhancing RAG, according to one or more example embodiments. One or more operations in process 1200 may be performed by at least one processor (e.g., processor 1912) of the QP system.

As shown in FIG. 12, one or more operations in process 1200 may be similar to one or more operations in process 100 in FIG. 1. Thus, similar descriptions are omitted for conciseness.

As illustrated in FIG. 12, at operation S1210, the at least one processor may be configured and/or programmed to obtain a query, in the similar manner as operation S110 in process 100. The process then proceeds to operation S1220.

At operation S1220, the at least one processor may be configured and/or programmed to identify a plurality of keywords associated with the query, in the similar manner as described above in relation to operation S120 in process 100. The process then proceeds to operation S1230.

At operation S1230, the at least one processor may be configured and/or programmed to perform graph-based RAG to identify a plurality of sub-graphs from a knowledge graph relevant to the query, in the similar manner as described above in relation to operation S130 in process 100. The process then proceeds to operation S1235.

At operation S1235, the at least one processor may be configured and/or programmed to generate a plurality of summary entries describing the plurality of sub-graphs.

In particular, for example, returning to the example in FIG. 2 and FIG. 6, the plurality of seed nodes and the plurality of flow-selected nodes may be selected as described above, where the plurality of sub-graphs may be identified. Here, four sub-graphs may be identified corresponding to the four seed nodes representing entities “Elaine Benes”, “women”, “feminism”, and “feminist philosophy”, as shown in FIG. 6.

In this regard, a summary entry may be generated to describe each of the sub-graphs including the entities “Elaine Benes”, “women”, “feminism”, and “feminist philosophy” and their associated flow-selected nodes.

For example, the QP system may generate a summary entry describing the subgraph containing the seed node representing the entity “Elaine Benes” and associated flow-selected nodes, where the summary entry may be “Elaine Benes: this cluster encapsulates the interplay between identity, morality, and gender, as presented through Elaine's character and her complex world, illustrating . . . ”.

Similarly, the QP system may generate a summary entry describing the subgraph containing the seed node representing the entity “women” and associated flow-selected nodes, where the summary entry may be “Women: the cluster is anchored by the concept of “Women”, juxtaposed against “Men”, highlighting the gender dynamics where women are often seen as “the Other” and defined relative to men's experiences of freedom and autonomy . . . ”.

Similarly, the QP system may generate a summary entry describing the subgraph containing the seed node representing the entity “feminism” and associated flow-selected nodes, where the summary entry may be “Feminism: the cluster revolves around “Feminism” as a central thematic source that advocates for women's rights and equality, linking various philosophical frameworks and figures. The source node anchors the cluster by . . . ”.

Similarly, the QP system may generate a summary entry describing the subgraph containing the seed node representing the entity “feminist philosophy” and associated flow-selected nodes, where the summary entry may be “Feminist Philosophy: The cluster collectively represents the intersection of feminist philosophy and sports, emphasizing the cultural and societal barriers women face in traditionally male-dominated activities. It illustrates . . . ”.

According to example embodiments, the plurality of summary entries may be generated using the LLM. According to example embodiments, the plurality of summary entries may be generated using the LLM and the prompting technique based on a fourth prompt.

According to example embodiments, the fourth prompt may specify a goal, and a plurality of instructions associated with cluster (sub-graphs) to generate the plurality of summary entries to the LLM, where the LLM may perform operations in accordance with the prompt.

For example, the goal may specify “Please analyze the following cluster of entities and their relationships, then provide a concise summary of how they are connected and what this cluster represents”.

Further, the instructions may specify “For Source Node: {source_node} and Cluster Nodes: {nodes_text}, please provide a summary that explains: (1) How are these entities related to each other? (2) What concept or theme does this cluster represent? (3) The significance of the connections between these entities. (4) How does the source node connect to the other entities in this cluster?”. According to example embodiments, the fourth prompt may also specify a note, such as “Keep the summary concise but informative, focusing on the relationships and thematic connections”.

According to example embodiments, the flow diffusion process may result in entity clusters (plurality of sub-graphs) that capture different semantic aspects of the query. Each cluster may be summarized using LLM prompting with relevant chunks to extract key concepts and relationships. The process then proceeds to operation S1240.

At operation S1240, the at least one processor may be configured and/or programmed to generate a response to the query based on the plurality of summary entries.

According to example embodiments, the response may be generated using the LLM.

In this regard, it is understood that the response may be generated using the LLM using any appropriate process, technique, tools, and the like. For example, the QP system may simply forward the plurality of summary entries to the LLM. Accordingly, the LLM may process the plurality of summary entries and provide the response to the QP system.

According to example embodiments, the at least one processor may be configured and/or programmed to also provide the generated response to the user. Here, the generated response may be provided to the user using any appropriate process, technique, tools, and the like. For example, The QP system may be communicatively coupled to a user equipment (UE) of the user, where the QP system may transmit the generated response to a graphical user interface at the UE via a wireless connection.

According to example embodiments, the structured cluster summaries may be provided as organized contextual input to downstream LLMs using carefully crafted prompts. Each prompt may incorporate role definitions, goal specifications, and the retrieved knowledge in a structured format, enabling the LLM to generate comprehensive and logically consistent responses grounded in semantically coherent reasoning paths rather than disconnected fragments.

Upon performing operation S1240, the process 1200 may be ended or be terminated. Alternatively, process 1200 may return to operation S1210, such that the at least one processor may be configured and/or programmed to repeatedly perform, for at least a predetermined amount of time, the obtaining the query (at operation S1210), the identifying the plurality of keywords (at operation S1220), the performing the graph-based RAG (at operation S1230), the generating the plurality of summary entries (at operation S1235), and the generating the response (at operation S1240).

According to example embodiments, one or more operations in process 100, process 1100, and/or process 1200 may be modified and combined with each other without limitation.

For example, process 100 and process 1100 may be combined, where the QP system may determine whether the query should be segmented into the plurality of subqueries based on a predefined criteria (e.g., length of the query, complexity of query, etc.). In this regard, in response to determining that the query should be segmented into the plurality of subqueries, operation S1115 to operation S1140 in process 1100 may be performed. On the other hand, in response to determining that the query should not be segmented into the plurality of subqueries, operation S120 to operation S140 in process 100 may be performed.

In view of the above, example embodiments of the present disclosure may provide a frame work that enables dynamic, query-aware graph traversal via principled flow diffusion mechanisms. The key insight in the present disclosure may involve the fact that effective graph-based retrieval and reasoning requires query-adaptive exploration, where the traversal strategy dynamically aligns with the semantic needs of each query.

The main contribution of example embodiments of the present disclosure may include the following.

The first contribution may include a query-aware flow diffusion framework. In particular, example embodiments of the present disclosure may introduce the first principled flow diffusion process for graph-based RAG that dynamically incorporates query semantics through semantic alignment-based edge weighting. Unlike existing graph-based RAGs that apply static patterns, example embodiments of the present disclosure may modulate the flow diffusion process based on continuous semantic alignment between query terms and graph elements, creating query-specific exploration patterns that naturally discover relevant reasoning paths. The query-adaptive flow mechanism of the example embodiments of the present disclosure may modulate flow probabilities at each step, focusing computational resources on promising regions while maintaining linear complexity, thereby enabling the discovery of query-specific reasoning paths rather than static exploration pattern.

The second contribution may include an optimization and statistical guarantees for query-aware traversal. Unlike existing heuristic RAG approaches, example embodiments of the present disclosure may provide the first rigorous theoretical analysis for query-related subgraph guarantees. Specifically, it is established that convergence properties showing that the diffusion process described above converges to a unique stationary distribution exponentially fast. Interestingly, this convergence is query-dependent, meaning that the convergence properties adapt to the semantic structure induced by each query. Furthermore, the subgraph recovery guarantees is provided, proving that relevant subgraphs are recovered with high probability under mild conditions.

The third contribution may include a comprehensive. Extensive experiments across multiple benchmarks has demonstrated consistent improvements over existing graph-based RAG baselines. On question-answering tasks, the query-aware flow diffusion graph-based RAG of example embodiments of the present disclosure outperforms SOTA RAG processes (e.g., GraphRAG, LightRAG, and PathRAG) across all five evaluation dimensions (comprehensiveness, diversity, logicality, relevance, and coherence) on six diverse domains from the ultra-domain benchmark, with particularly notable gains in comprehensiveness and diversity. For text-to-SQL schema linking, the query-aware flow diffusion graph-based RAG of example embodiments of the present disclosure achieves 26.7% execution accuracy on SQLite and 23.7% on Snowflake databases (vs. 21.5% and 16.3% for spider-agent) while requiring 13.3-54.5% fewer LLM calls, demonstrating both effectiveness and LLM call efficiency.

FIG. 13 illustrates a flow diagram of an example process 1300 for enhancing text-to-SQL, according to one or more example embodiments. One or more operations in process 1300 may be performed by at least one processor (e.g., processor 1912) of the QP system.

As shown in FIG. 13, one or more operations in process 1300 may be similar to one or more operations in process 100 in FIG. 1 and/or process 1100 in FIG. 11. Thus, similar descriptions are omitted for conciseness.

As illustrated in FIG. 13, at operation S1310, the at least one processor may be configured and/or programmed to obtain a query, in the similar manner as operation S110 in process 100. The process then proceeds to operation S1320.

At operation S1320, the at least one processor may be configured and/or programmed to segment the query into a plurality of subqueries, in the similar manner as operation S1115 in process 1100.

For example, the query may include “Please help me find the film category with the highest total rental hours in cities whose names either start with ‘A’ or contain a hyphen”.

In this regard, the query may be segmented into the plurality of subqueries including, for example, a first subquery including filtering cities having names either start with ‘A’ or contain a hyphen, a second subquery including connecting cities to addresses and customers, a third subquery including finding film rentals by these customers, a fourth subquery including linking rentals to films to compute rental hours, and a fifth subquery including determining the film categories with the highest total rental hours.

According to example embodiments, the query may be segmented into the plurality of subqueries using the LLM. More specifically, the query may be segmented into the plurality of subqueries using LLM-based decomposition.

In view of the above, complex natural language queries may be decomposed into interpretable subqueries (e.g., via an LLM call), with each subquery corresponding to a semantically meaningful fragment of the original question. This modularization facilitates targeted reasoning and localized schema exploration. The process then proceeds to operation S1330.

At operation S1330, the at least one processor may be configured and/or programmed to identify a plurality of keywords associated with each of the plurality of subqueries, in the similar manner as described above in relation to operation S120 in process 100 and/or operation S1120 in process 1100.

For example, during operation S1330, keyword “cities” may be identified for the first subquery; keywords “cities”, “addresses”, and “customers” may be identified for the second subquery; keywords “film rentals” and “customers” may be identified for the third subquery; keywords “films” and “rentals” may be identified for the fourth subquery; and keywords “film categories” and “rentals” may be identified for the fifth subquery. The process then proceeds to operation S1340.

At operation S1340, the at least one processor may be configured and/or programmed to identify a plurality of paths relevant to the plurality of subqueries. The plurality of paths may be identified from a schema graph.

According to example embodiments, the plurality of paths may be identified using a flow diffusion process based on the schema graph and the associated plurality of keywords. For example, a first path relevant to (associated with) a first subquery may be identified based on a first plurality of keywords associated with the first subquery, a second path relevant to (associated with) a second subquery may be identified based on a second plurality of keywords associated with the second subquery, and the like.

According to example embodiments, the schema graph may include a plurality of graph nodes and a plurality of connections between the plurality of graph nodes. The plurality of graph nodes may represent a plurality of entries associated with data tables in a database, while the plurality of connections may represent a plurality of relationships between the plurality of entries.

In this regard, the QP system may identify the plurality of paths, which may include a number of nodes (plurality of path nodes) and a number of connections from the plurality of graph nodes and the plurality of connections in the schema graph, forming a path (e.g., a path leading from one starting node through a number of nodes to an end node). Here, the nodes and connections in the identified plurality of paths may be most relevant to the query in comparison to other nodes and connections in the schema graph.

The plurality of entries and classes here may include any kind of entries within a data table (structured data) as well as the class of the data table itself, such as a category, entries in said category, and the like. For example, the data table may include a table specifying “aircraft data”, where entries in said table may specify various parameters and information associated with “aircraft data”, such as “ranges”, “models”, “aircraft codes”, and the like. Accordingly, plurality of graph nodes may include nodes representing the “aircraft data”, “ranges”, “models”, “aircraft codes”, and the like.

Further, the plurality of connections may represent a plurality of relationships between the plurality of entries and classes. The plurality of relationships may include any kind of relationships, such as association type, semantic relationship, and the like. For example, the connection between a node representing “aircraft data” and a node representing “ranges” may represent a relationship indicating that the “range” is part of the “aircraft data”.

According to example embodiments, the schema graph may be created by the QP system based on a database containing certain structured information (e.g., data tables). Examples of operations for creating the schema graph are described below with reference to FIG. 14.

According to example embodiments, the flow diffusion process here may be similar to the flow diffusion process described above in relation to process 100.

According to example embodiments, the at least one processor may be configured and/or programmed to identify the plurality of paths by, for each subquery from among the plurality of subqueries: identifying a plurality of sub-paths relevant to the respective subquery (e.g., to the each subquery) using the flow diffusion process based on the schema graph and the plurality of keywords associated with the respective subquery, wherein each of the plurality of sub-paths may include a plurality of sub-path nodes and a plurality of connections between the plurality of sub-path nodes in the schema graph; determining path scores indicating relevance between the plurality of sub-paths and the respective subquery; and selecting one of the plurality of sub-paths having the path score that is highest in comparison to other sub-paths of the plurality of sub-paths. Here, the selected sub-path for a particular subquery may correspond to one of the plurality of paths associated with said particular subquery.

Examples of operations for identifying the plurality of paths are described below with reference to FIG. 16. The process then proceeds to operation S1350.

At operation S1350, the at least one processor may be configured and/or programmed to generate a response to the query based on the plurality of paths.

Here, the response may include any kind of response to the query, such as an answer. Further, the response may be in the natural language format.

According to example embodiments, the response may be generated based on a structured query language (SQL) corresponding to the plurality of paths.

In particular, according to example embodiments, the at least one processor may be configured and/or programmed to generate the response by: generating a structured query language (SQL) based on an aggregation of the plurality of paths; and generating the response based on the SQL.

According to example embodiments, the response and/or the SQL may be generated using the LLM.

In this regard, it is understood that the SQL may be generated using any appropriate process, technique, tools, and the like. For example, the SQL may be generated by transmitting the plurality of paths to the LLM (e.g., via an application programming interface (API)), where the LLM may generate the SQL based on an aggregation of the plurality of paths and provide the SQL to the QP system.

Similarly, it is understood that the response may be generated using any appropriate process, technique, tools, and the like. For example, the QP system may simply forward the SQL to the LLM, where the LLM may process the SQL and provide the response to the QP system.

According to example embodiments, the at least one processor may be configured and/or programmed to also provide the generated response to the user. Here, the generated response may be provided to the user using any appropriate process, technique, tools, and the like. For example, The QP system may be communicatively coupled to a user equipment (UE) of the user, where the QP system may transmit the generated response to a graphical user interface at the UE via a wireless connection.

Upon performing operation S1350, the process 1300 may be ended or be terminated. Alternatively, process 1300 may return to operation S1310, such that the at least one processor may be configured and/or programmed to repeatedly perform, for at least a predetermined amount of time, the obtaining the query (at operation S1310), the segmenting the query (at operation S1320), the identifying the plurality of keywords (at operation S1330), the identifying the plurality of paths (at operation S1340), and the generating the response (at operation S1350). For instance, the at least one processor may continuously (or periodically) receive more queries from the user (same user or different users), and then restart the obtaining the query (at operation S1310), the segmenting the query (at operation S1320), the identifying the plurality of keywords (at operation S1330), the identifying the plurality of paths (at operation S1340), and the generating the response (at operation S1350).

In view of the above, the above processes may reduce schema exploration complexity, minimize inference latency by reducing required LLM calls, and improve query-generation accuracy.

More specifically, the above processes may provide a training-free framework for structured reasoning over large and heterogeneous schemas. Utilizing the graph diffusion, the above processes may involve stimulating the spread of information (or mass) from a set of seed nodes to their neighbors along a weighted graph. The schema graph may consist of tables and columns as nodes, with edges/connections representing known or inferred relationships.

The above processes may formulate schema linking as a sequence of flow optimization problems, each modeling a local flow diffusion process, where mass is diffused from seed nodes based on their semantic relevance to a given user subquery.

The chain property may be attributed to the stepwise decomposition of the user query into subqueries and corresponding flow problems. Each subquery may initiate its own localized diffusion process, producing a set of sub-paths that are semantically relevant. These sub-paths may then be ranked and combined into a coherent multi-hop reasoning chain that supports SQL generation. This chaining of flow diffusion may allow progressive construction of query-relevant schema paths, improving both accuracy and efficiency.

More specifically, as further described below through FIG. 14 to FIG. 18, the above processes may provide the following technical advantages.

Systematic Recovery of Implicit Schema Relationships. The above processes may involve formalization of the concepts of primary key (PK) and foreign key (FK). The definitions of these elements (see below in relation to FIG. 14) may establish the foundation for systematically recovering missing PK/FK relationships. By leveraging statistical uniqueness, referential containment, and naming heuristics, the above processes may infer implicit schema links and transform fragmented database schemas into connected graphs, thereby enabling accurate multi-table joins even when explicit constraints are absent.

Training-Free Automatic Flow-Based Schema Linking with Locality. The above processes may utilize the flow diffusion framework that explicitly models local semantic transport via query-aware flow, enabling the above processes to efficiently and automatically explore schema graphs without redundant global searches or extensive subgraph extraction. Unlike column/table-based search processes or react-style exploration processes in the related art, the above processes may achieve up to an ≈95% reduction in LLM calls, significantly improving latency.

Structured Multi-Hop Reasoning. The above processes may leverage flow diffusion to pinpoint coherent multi-hop reasoning paths (paths of relevant columns and tables). This process may effectively avoid redundant or irrelevant subgraphs and identify critical bridge nodes (intermediate schema elements frequently overlooked by approaches in the related art), enabling precise handling of complex join relationships in enterprise databases.

Improved Accuracy on Complex Enterprise Schemas. Comprehensive experiments have been performed to demonstrate substantial gains in query generation accuracy compared to processes of the related art, particularly excelling at complex analytical queries involving challenging join paths in real-world enterprise databases.

In addition, the number of LLM calls may be reduced, thereby reducing overall computational cost as well as monetary cost associated.

FIG. 14 illustrates a flow diagram of an example process 1400 for creating schema graph, according to one or more example embodiments. One or more operations in process 1400 may be performed by at least one processor (e.g., processor 1912) of the QP system.

As illustrated in FIG. 14, at operation S1410, the at least one processor may be configured and/or programmed to obtain a plurality of data tables.

The plurality of data tables may include certain information in a structured form, such as a table containing table entries (column and rows of data), a list containing entries (rows of data), and the like. According to example embodiments, information in the plurality of data tables may be in natural language format.

According to example embodiments, the plurality of data tables may be obtained via a database. The database may include and store various data, which may be arranged in a structured manner (e.g., structured data). Such structured data stored in the database may correspond to the plurality of data tables.

It is understood that the plurality of data tables may be obtained using any appropriate process, technique, tool, and the like. For example, the QP system may be communicatively coupled to the database (e.g., local connection with a local database) storing various data associated with an airport in a structured format. Here, the data associated with the airport in the structured format may correspond to the plurality of data tables, where the QP system may simply obtain the plurality of data tables from the database (e.g., transmitting a request to receive the plurality of data tables).

Further, the plurality of data tables (data associated with the airport in the structured format) may include, for example, a flight table including entries associated with flight ID, flight number, departure airport, status, and aircraft code; a boarding pass table including entries associated with boarding number, flight ID, ticket number, and seat number; and an aircraft data table including entries associated with model, range, and aircraft code.

It is also understood that, in certain implementation, the plurality of data tables may include any kind of data arranged in any kind of structured form (e.g., any kind of structured data not limited to table). The process then proceeds to operation S1420.

At operation S1420, the at least one processor may be configured and/or programmed to determine, for each of the plurality of data tables, a plurality of entries and a plurality of relationships between the plurality of entities in the respective data table.

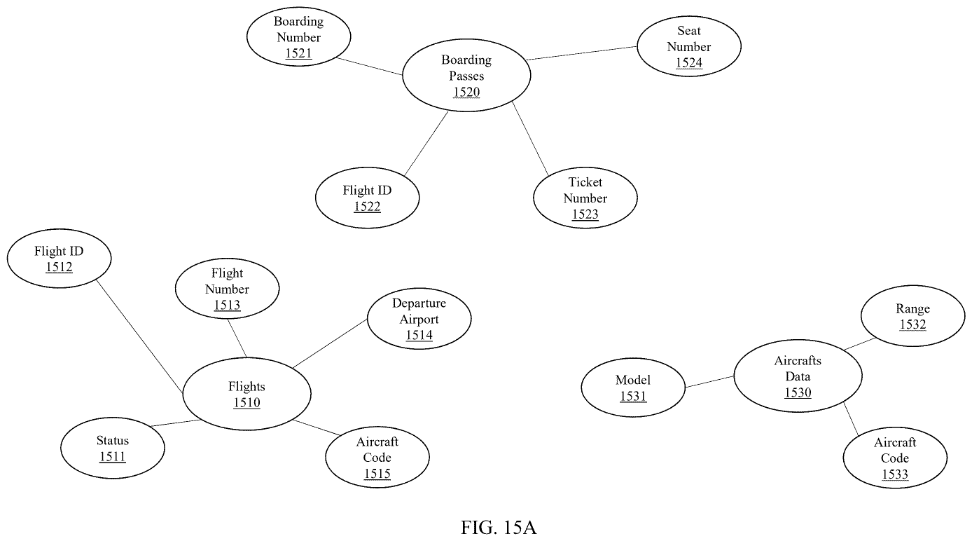

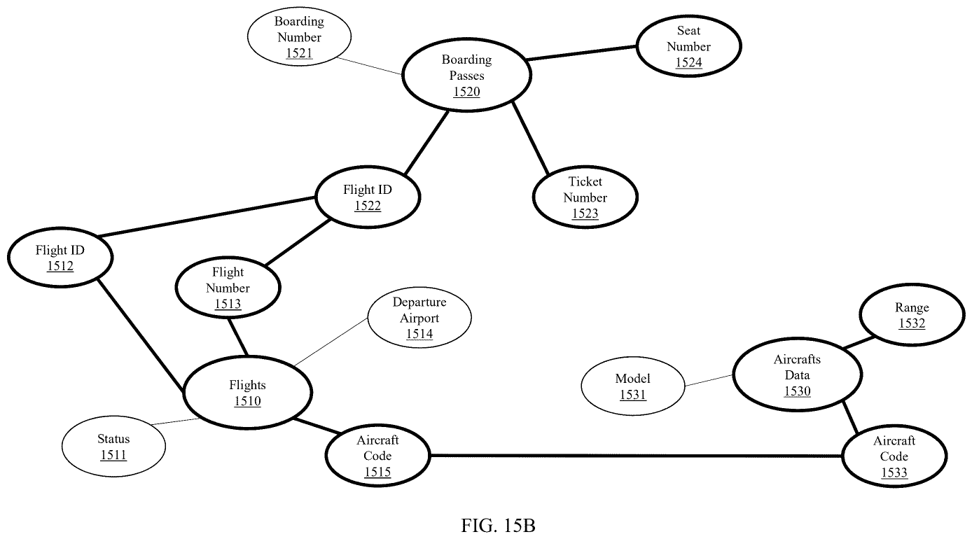

FIG. 15A to FIG. 15B illustrate example plurality of entries and plurality of relationships, according to one or more example embodiments.

In this regard, the QP system may identify “aircraft data”, “range”, “model”, and “aircraft code” as the plurality of entries for the aircraft data table, and may identify the relationship between the “aircraft data” and “ranges” as a relationship indicating that the “range” is part of the “aircraft data”, as shown via the connections between aircraft data 1530, model 1531, range 1532, and aircraft 1533 in FIG. 15A.

The same applies to flights 1510, status 1511, flight ID 1512, flight number 1513, departure airport 1514, and aircraft code 1515, as well as boarding passes 1520, boarding number 1521, flight ID 1522, ticket number 1523, and seat number 1524 as shown in FIG. 15A.

It is understood that the example shown in FIG. 15A and FIG. 15B are provided for descriptive purpose, and is not intended to limit the scope of the present disclosure in any way. For example, the number of graph nodes and connections can be any, the graph nodes and connections can be in any configuration and arrangements, the graph node may correspond to any kind of entries, the connection may correspond to any kind of relationship, and the like.

According to example embodiments, the plurality of entries and the plurality of relationships may be determined using the LLM. The process then proceeds to operation S1430.

At operation S1430, the at least one processor may be configured and/or programmed to generate the schema graph. The schema graph may be generated based on the plurality of entries and the plurality of relationships of the plurality of data tables.

In particular, the schema graph may include a plurality of graph nodes and a plurality of connections between the plurality of graph nodes, where the plurality of graph nodes may correspond to the plurality of entries determined from the plurality of data tables during operation S1420, and where the plurality of connections may correspond to the plurality of relationships determined from the plurality of data tables during operation S1420.

According to example embodiments, the schema graph may be negated by determining further connections and relationships between entries from two or more data tables.

In particular, as shown in the example of FIG. 15A, the determined plurality of entries and plurality of relationships are separated into isolated groups based on the associated data table. For example, flights 1510, status 1511, flight ID 1512, flight number 1513, departure airport 1514, and aircraft code 1515 as well as their relationships may be in a first group; boarding passes 1520, boarding number 1521, flight ID 1522, ticket number 1523, and seat number 1524 as well as their relationships may be in a second group; and aircraft data 1530, model 1531, range 1532, and aircraft 1533 as well as their relationships may be in a third group.

In this regard, the QP system may determine a relationship between an entity from one group and an entity from another group. More specifically, as shown in the example of FIG. 15B, the QP system may determine a relationship between flight ID 1522 to flight ID 1512, a relationship between flight ID 1522 to flight number 1513, and a relationship between aircraft code 1515 and aircraft code 1533.

Accordingly, the schema graph may be formed/generated by connecting various entries from various groups.

According to example embodiments, the schema graph may be generated (the relationships/connections between entries from different groups may be determined) based on a three-pronged approach.

In particular, fundamental challenge in enterprise-scale text-to-SQL process may involve the discovery and representation of schema relationships, particularly when explicit foreign key (FK) constraints are missing. This challenge may be critical because, without properly identified relationships, the schema graph may become a collection of disconnected “islands” of data (e.g., as shown in FIG. 15A), making it difficult to generate correct multi-table queries that join related information. In this regard, in order to address this challenge, a primary key (PK) concept may be defined based on relational database theory.

It is noted here that the following provide descriptions of expressions, where the representations may be different from equations (1)-(20) described above.

Specifically, according to example embodiments, for a relation [symbol] with schema S_{R}, the primary key (PK) may be defined as PK⊆ [symbol] . Further, the PK may correspond to a minimal set of attributes such that the PK may include (1) a uniqueness property defined as ∀tᵢ, tⱼ∈ [symbol] , tᵢ≠tⱼ→tᵢ[PK]≠tⱼ[PK]; and (2) a minimality property where no proper subset of PK may satisfy the uniqueness property.

The above definition may enable reliable entity identification within a relation, forming the basis for database integrity. The uniqueness property may ensure that each entity can be distinctly addressed, while minimality property may guarantee that no attribute in the key is redundant, thereby removing any attribute that may violate uniqueness.

Further, the foreign key (FK) may establish a referential integrity constraint between relations, where, for relations [symbol] ₁ and [symbol] ₂ with schema [symbol] and [symbol] , respectively, the foreign key (FK) may be defined as FK⊆ [symbol] , while referencing the primary key PK⊆ [symbol] . The above may ensure: (1) referential integrity defined as ∀t₁∈ [symbol] , ∃t₂∈ [symbol] , such that t₁[FK]=t₂[PK]; and (2) domain compatibility where attributes in FK and PK may have compatible domains.

The above definition may formalize the critical concept of relationship enforcement between relations. Referential integrity may guarantee that relationships in the database mirror real-world connections between entities, while domain compatibility may ensure that the attributes being compared are semantically meaningful.

It is noted here that, for databases employed in enterprise environments, said databases may often be lacking in explicitly defined primary and foreign key constraints, leading to fragmented schemas and incomplete join paths. In this regard, the above processes may allow systematic inference of both PK and FK using a multi-signal analysis grounded in the definitions described above.

More specifically, the primary key candidacy may be assessed by analyzing the uniqueness ratio and null value distribution for each column and relevant combinations of columns, directly reflecting the uniqueness and minimality requirements according to the definition of PK. Composite keys may be considered when no single column suffices.

Further, foreign key candidates may be identified by verifying whether a column's values (or tuples of values for composite keys) are fully or predominantly contained within the primary key values of another table, capturing referential integrity as formalized in the definition of FK.

Furthermore, particular standard naming patterns (e.g., id, table_id, pk_column, fk_table_column, etc.) may be leveraged to further strengthen PK and FK inference.

Accordingly, by integrating the above signals, confidence scores may be assigned to all inferred links and a connected schema graph may be reconstructed, enabling robust multi-table query generation even in the absence of explicit constraints.

In particular, as shown in FIG. 15B, the above process may effectively recover key relationships and bridges previously disconnected schema components, supporting end-to-end relational reasoning. FIG. 15B may reveal FK and PK connections inferred using statistical uniqueness, referential containment, and naming conventions, transforming isolated tables into a connected schema.

It is noted here that in FIG. 15B, flights 1510, boarding passes 1520, and aircraft data 1530 may correspond to the classes of the data tables; range 1532 may correspond to a PK column; seat number 1524, flight number 1513, and aircraft code 1515 may correspond to FK columns; and ticket number 1523, flight ID 1522, flight ID 1512, and aircraft code 1533 may correspond to PK and FK columns. Further, the connection between the range 1532 and aircraft data 1530 may represent a PK table; the connections between aircraft code 1533 and aircraft code 1515, the connections between flight ID 1522 and flight ID 1512, and the connections between flight ID 1522 and flight number 1513 may correspond to PK-FK table; and the connection between the boarding passes 1520 and seat number 1524, the connection between boarding passes 1520 and ticket number 1523, the connection between the boarding passes 1520 and flight ID 1522, the connection between flights 1510 and flight ID 1512, the connection between flights 1510 and flight number 1513, the connection between flights 1510 and aircraft code 1515, and the connection between aircraft data 1530 and aircraft code 1533 may correspond to FK table.

In view of the above, the above processes may enable automatic discovery of implicit schema relationships in databases with missing foreign key constraints. The three-pronged approach may be employed that analyzes statistical uniqueness patterns, referential containment relationships, and naming conventions to infer primary and foreign keys with confidence scores. This may enable transformation of disconnected table “islands” into a cohesive schema graph essential for multi-table query generation.

FIG. 16 illustrates a flow diagram of an example process 1600 for identifying a plurality of paths, according to one or more example embodiments. One or more operations of process 1600 may be part of operation S1340 in process 1300, and may be performed by at least one processor (e.g., processor 1912) of the QP system.

As illustrated in FIG. 16, at operation S1610, the at least one processor may be configured and/or programmed to identify, for each of the plurality of subqueries (obtained during operation S1320 in process 1300), a plurality of sub-paths relevant to the respective subquery.

The plurality of sub-paths may be identified using the flow diffusion process based on the schema graph and the plurality of keywords associated with the respective subquery (identified during operation S1330 in process 1300). Further, each of the plurality of sub-paths may include a plurality of sub-path nodes and a plurality of connections between the plurality of sub-path nodes in the schema graph.

For example, a first plurality of sub-paths relevant to (associated with) a first subquery may be identified based on a first plurality of keywords associated with the first subquery, a second plurality of sub-paths relevant to (associated with) a second subquery may be identified based on a second plurality of keywords associated with the second subquery, and the like.

According to example embodiments, each of the plurality of sub-paths may include a seed node and a plurality of flow-selected nodes, which may be determined at least partially in the similar manner as described above in relation to process 500, process 700, and process 900. In this regard, according to example embodiments, the plurality of sub-paths may be different from the plurality of sub-graphs described above in relation to process 100, where the sub-path may include a number of nodes and a number of connections that connects one node to one other to form a path (e.g., a path leading from one starting node through a number of nodes to an end node), while the sub-graph may include a number of nodes and a number of connections that connects multiple nodes to multiple others forming branches (e.g., branches leading from one starting node through a number of nodes to multiple end nodes).

More specifically, according to example embodiment, for each subquery, the QP system may identify relevant graph nodes in the schema graph (tables or columns) as seed nodes, then injects query-specific signals and performs query-aware flow diffusion over the weighted schema graph. This diffusion process may uncover related schema elements and latent bridge nodes that connect distant regions of the schema.

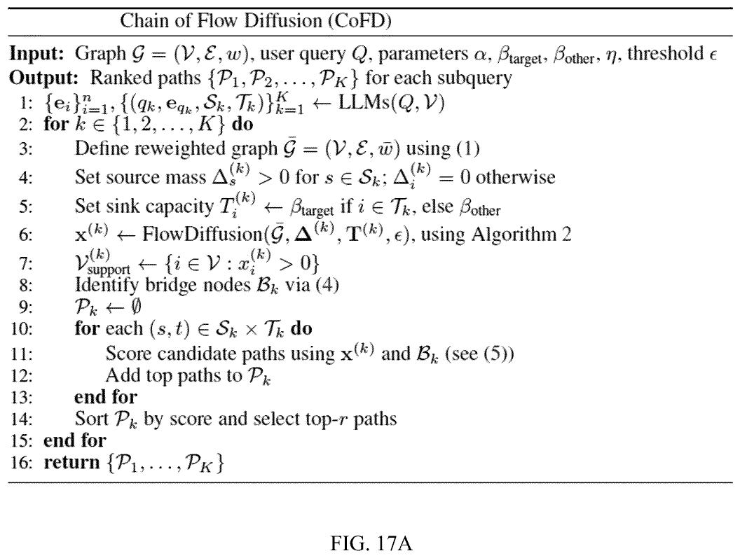

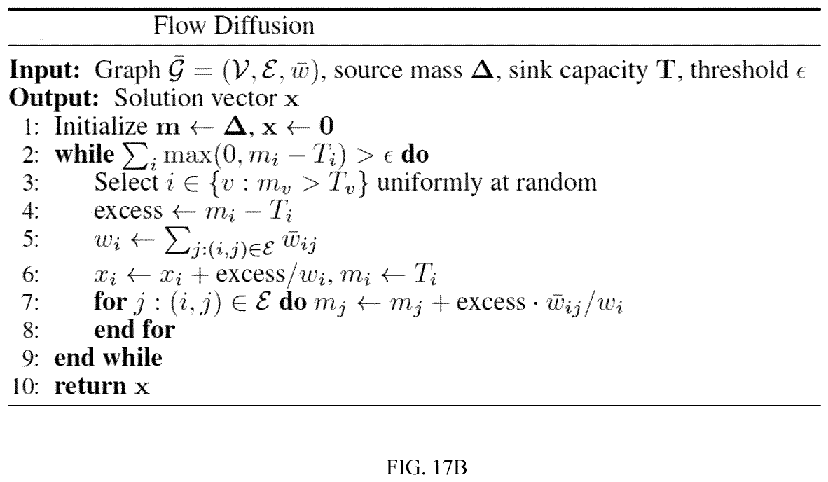

Additional descriptions associated with the identification of the plurality of sub-paths are provided below in relation to FIG. 17A and FIG. 17B. The process then proceeds to operation S1620.

At operation S1620, the at least one processor may be configured and/or programmed to determine, for each of the plurality of subqueries, path scores indicating relevance between the plurality of sub-paths and the respective subquery.

For example, the QP system may determine a first score indicating relevance between a first sub-path of the first plurality of sub-paths and the first subquery, a second score indicating relevance between a second sub-path of the first plurality of sub-paths and the first subquery, a third score indicating relevance between a first sub-path of the second plurality of sub-paths and the second subquery, a fourth score indicating relevance between a second sub-path of the second plurality of sub-paths and the second subquery, and the like.

More specifically, according to example embodiments, the paths traversed during the flow diffusion may be evaluated and scored based on structural coherence and semantic alignment with the subquery. The QP system may rank the resulting paths, prioritizing those with high query relevance and strong connectivity.

Additional descriptions associated with the determination of the path scores are provided below in relation to FIG. 17A and FIG. 17B. It is also noted here that the path score may be in any format, such as discrete scores. The process then proceeds to operation S1630.

At operation S1630, the at least one processor may be configured and/or programmed to select, for each of the plurality of subqueries, one of the plurality of sub-paths having the path score that is highest in comparison to other sub-paths of the plurality of sub-paths.

For example, the QP system may determine a first score indicating relevance between a first sub-path of the first plurality of sub-paths and the first subquery as 5, a second score indicating relevance between a second sub-path of the first plurality of sub-paths and the first subquery as 9, a third score indicating relevance between a first sub-path of the second plurality of sub-paths and the second subquery as 3, a fourth score indicating relevance between a second sub-path of the second plurality of sub-paths and the second subquery as 7.

Accordingly, for the first subquery, the QP system may select the second sub-path as the one of the plurality of sub-paths having the path score that is highest in comparison to other sub-paths of the plurality of sub-paths (9). Similarly, for the second subquery, the QP system may select the second sub-path as the one of the plurality of sub-paths having the path score that is highest in comparison to other sub-paths of the plurality of sub-paths (7).

Accordingly, the selected one of the plurality of sub-paths may correspond to one of the plurality of paths described above in relation to process 1300, where the selected one of the plurality of sub-paths for all of the plurality of subqueries correspond to the plurality of paths.

More specifically, according to example embodiments, the top top-ranked paths across all subqueries may be merged to produce a coherent SQL sketch. This structured sketch may serve as the input to downstream LLMs, which may synthesize the final executable SQL query.

FIG. 17A and FIG. 17B illustrate example algorithms for identifying a plurality of paths, according to one or more example embodiments.

In particular, according to example embodiments, the schema graph may be modeled as an undirected, connected, weighted graph, according to the following expression.

[symbol]

=( [symbol] ,ε,w) (21)

Here, V may represent schema elements (tables/columns; graph nodes), E may represent relationships (edges; connections). In addition, w may represent an encoding of semantic or structural similarity, and may be defined as w:ε→ [symbol] ₊.

In this regard, for (i, j)∈ε, wᵢⱼ=wⱼᵢ, and w∈ [symbol] ^{m} may collect edge/connection weights. The adjacency matrix may be defined as A∈{0,1}^{n×m}, and may satisfy Aⱼᵢ=1 if (i, j)∈ε, where the node degree may be defined as deg(i)=ΣⱼAᵢⱼ. The signed incidence matrix may be defined as B∈ [symbol] ^{m×n}, where W∈ [symbol] ^{m×m} is diagonal with W_{(i,j),(i,j)}=wᵢⱼ.

Here, after obtaining the user query, the user query may be segmented/decompose into subqueries {q₁, q₂, . . . , qₖ}. For each of the subqueries qₖ, source node (seed node) [symbol] (e.g., initial tables or columns in the schema graph that serve as starting points for reasoning) may be identified along with target node Tₖ (e.g., tables or columns that need to be accessed to complete the subquery). Subsequently, schema nodes v may be embedded with eᵥ∈ [symbol] ^{d} using pre-trained LLM, and similarly embed the subqueries. In this regard, the edge weights may combine the structural and semantic relevance according to the following expression.

w̅(i,j)=wᵢⱼ·f(eᵢ,eⱼ,e_{qk}) (22)

Here, ƒ may represent a function that captures the semantic relevance between nodes i, j and the subquery qₖ based on their embeddings.

The above equation (22) may allow dynamic adjustments of edge weights based on the semantic relevance of schema elements to the user query, focusing the flow diffusion process on paths that are most likely to be relevant for query execution. It is noted here that w̅(i, j) in equation (22) may be computed online as the schema graph is traversed for a specific subquery qₖ from one node to another, and may not be needed for the whole graph.

Unlike max-flow processes in the related art that are ill-suited for the multi-hop reasoning required in text-to-SQL tasks, the above processes may model schema traversal as a sequence of flow diffusion steps over a weighted graph. For each subquery qₖ, with sources Sₖ and targets Tₖ, the flow diffusion process may be performed according to the following expression.

$${min}_{{\{ {f}^{( k )} ∈ {ℝ}^{m} \}}_{k = 1}^{K}} \frac{1}{2} {\sum }_{k = 1}^{K} {( {f}^{( k )} )}^{T} \overline{W} {f}^{( k )} \qquad ( 23 )$$

$$subject to {Δ}^{( k )} + B \overline{W} {f}^{( k )} \leq {T}^{( k )} ∀ k ∈ [ K ]$$

Here, ƒ^{(k)} may represent the edge/connection flow for qₖ. W̅ may represent the diagonal matrix of adjusted weights w̅_{i,j}. Δ^{(k)} may represent the source vector, and may be defined according to the following expression.

$${Δ}_{i}^{( k )} = \{ \begin{matrix}α {\sum }_{j ∈ V} {T}_{j}^{( k )} & if i ∈ {𝒮}_{k} \\ 0 & otherwise\end{matrix} \qquad ( 24 )$$

T^{(k)} may represent the sink vector, and may be defined according to the following expression

$${T}_{i}^{( k )} = \{ \begin{matrix}{β}_{target} & if i ∈ {T}_{k} \\ {β}_{other} & otherwise\end{matrix} \qquad ( 25 )$$

Here, α>1 may ensure sufficient mass for diffusion, where β_{target} and βₒₜₕₑᵣ may control the sink capacities for target and non-target nodes, respectively.

Subsequently, the dual formulation of the flow problem may be solved via an efficient coordinate descent approach, leading to the algorithm shown in FIG. 17B. Here, the solution variables x may correspond to the Lagrange multipliers of the primal constraints, with x encoding the importance of each node for connecting sources to targets. The algorithm may run in O(d̅·∥Δ∥₁·log(1/∈)) time, updating only reachable nodes for efficiency. Here, d may represent the maximum degree. ∥Δ∥₁ may represent the total mass. € may represent the accuracy.

Further, the above processes may involve formal identification of bridge nodes as schema elements that mediate semantic connections between sources and targets. After computing the solution vector x^{(k)} using flow diffusion (line 6 in FIG. 17A), the set of bridge nodes Bₖ may be defined for subquery qₖ according to the following expressions.

$${ℬ}_{k} = {ℬ}_{k}^{FK} ⋃ {ℬ}_{k}^{PK} \qquad ( 26 )$$

$${ℬ}_{k}^{FK} = \{ v ∈ {V}_{support}^{( k )} \vert v / ∈ {𝒮}_{k} ⋃ {T}_{k} , IsF 𝒦 ( v ) \} \qquad ( 27 )$$

$${ℬ}_{k}^{PK} = \{ v ∈ {V}_{support}^{( k )} \vert v / ∈ {𝒮}_{k} ⋃ {T}_{k} , Is 𝒫 𝒦 ( v ) \} \qquad ( 28 )$$

Here, the bridge nodes may correspond to support nodes that are neither sources nor targets but are foreign or primary key columns.

Furthermore, each candidate paths p=(v₁, v₂, . . . , v_{L})∈ [symbol] may be scored according to the following expression.

$$Score ( p ) = ( {\prod }_{i = 1}^{L - I} {\overline{w}}_{{v}_{i} {v}_{i + 1}} \cdot {x}_{{v}_{i}} \cdot {x}_{{v}_{i + 1}} ) \cdot ( 1 + η {\sum }_{i = 1}^{L} 1 [ {v}_{i} ∈ {ℬ}_{k} ] \cdot {x}_{{v}_{i}} ) \qquad ( 29 )$$

Here, η>0 may represent a hyperparameter, and xᵥ_{ᵢ} may represent the node importance. The above may reward paths containing important bridge nodes, favoring accurate multi-hop reasoning in the schema graph.

Accordingly, the above processes may involve solving multiple coupled flow-diffusion problems, and incorporating query embeddings, enabling localized and context-aware diffusion. Further, the above processes may provide a training-free graph-based reasoning framework designed to improve schema linking and query generation in complex text-to-SQL tasks, while relying on a simple flow diffusion problem for efficient and effective schema reasoning. The above processes may also address the core challenge of reducing inference latency while preserving query accuracy by leveraging structured signal propagation over schema graphs.

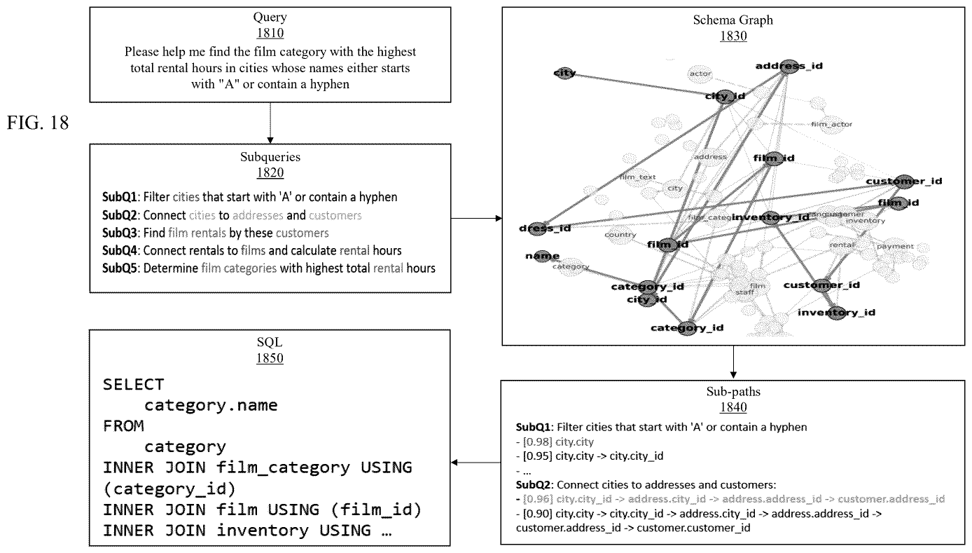

FIG. 18 illustrates an example visual representation of process 1300, according to one or more example embodiments. As shown in FIG. 18, the process may involve segmenting the query 1810 (e.g., the query “Please help me find the film category with the highest total rental hours in cities whose names either start with ‘A’ or contain a hyphen”) into a plurality of subqueries 1820 (e.g., subquery SubQ1, subquery SubQ2, subquery SubQ3, subquery SubQ4, and subquery SubQ5), where keywords are identified for each of the subqueries.

The process may then involve determining the plurality of sub-paths 1840 in the schema graph 1830 for each of the subqueries, and then selecting the sub-path with the highest score. In the example shown in FIG. 18, for subquery SubQ1, the path “city.city” has the highest score of 0.98 and is selected. Accordingly, the selected sub-paths of all the queries may correspond to the plurality of paths.

The process may then involve generating the SQL 1850 based on an aggregation of the plurality of paths, which may then be passed to an LLM to generate a response.

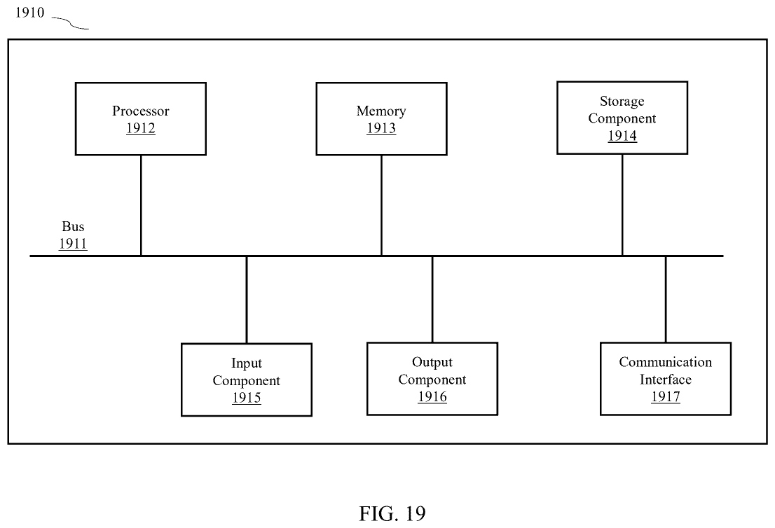

FIG. 19 illustrates a block diagram of example components in a system 1910, according to one or more example embodiments. The system 1910 may correspond to the QP system, thus the features associated with the QP system and the system 1910 may be similarly applicable to each other, unless being explicitly described otherwise.

As illustrated in FIG. 19, the system 1910 may include at least one bus 1911, at least one processor 1912, at least one memory 1913, at least one storage component 1914, at least one input component 1915, at least one output component 1916, and at least one communication interface 1917.

It is contemplated that the system 1910 may include more or less components than illustrated in FIG. 19, without departing from the scope of the present disclosure. For instance, in some embodiments, the system 1910 may include a plurality of storage components 1914, the input component 1915 and the output component 1916 may be implemented as a transceiver component, the memory 1913 and storage component 1914 may be implemented as a memory storage, and the like.

The bus 1911 may be configured to facilitate or enable communications among the components of the system 1910. Specifically, the bus 1911 may communicatively couple the components to each other and provide a means for data transfer and flow of control signals between the components. The bus 1911 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 1910 to enable communication and coordination between the components within the system 1910 in real-time (or near real-time).

The processor 1912 may be implemented in hardware, firmware, or a combination of hardware and software, and may be configured to handle real-time (or near real-time) data processing and control of the control system 1910. The processor 1912 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 1910. In some implementations, the processor 1912 may be capable of being programmed to perform one or more operations described herein. Further, the processor 1912 may include a plurality of processing units, each of which is dedicated to performing a specific operation.

The memory 1913 may include one or more mediums for storing temporary data, runtime variables, program instructions, and buffers required for the operations of the control system 1910. The memory 1913 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 1910 to store information and/or instructions for use by the processor 1912.

The storage component 1914 may be configured to store non-volatile data, such as firmware, configuration settings, calibration data, information, and/or software related to the operation and use of the system 1910. For example, the storage component 1914 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to example embodiments, the storage component 1914 may be configured to store computer-readable or computer-executable instructions for implementing one or more operations of the system 1910. The storage component 1914 may provide the stored information to the memory 1913 for the execution of the processor 1912.

The input component 1915 may include one or more input components that permit the system 1910 to receive information, such as via user input (e.g., a touch screen display, a keyboard, a keypad, a mouse, a button, a switch, and/or a microphone). The output component 1916 may include one or more output components that provide output information from the system 1910 (e.g., a display, a speaker, a navigation device, one or more light-emitting diodes (LEDs), etc.) According to example embodiments, the input component 1915 and/or the output component 1916 may be optional and may be excluded from the system 1910.

The at least one communication interface 1917 may include a transceiver-like component (e.g., a transceiver and/or a separate receiver and transmitter) that enables the system 1910 to communicate with other components (e.g., ECUs, user devices, etc.), such as via a wired connection, a wireless connection, or a combination of wired and wireless connections. For example, communication interface 1917 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 1917 may include at least one input/output (I/O) interface, at least one network interface, at least one storage interface, or the like, that enable the components 1912-1916 to communicate with other components. Further, the communication interface 1917 may include one or more application programming interfaces (APIs) that allow the system 1910 (or one or more components included therein) to communicate with one or more software applications (e.g., software application deployed in the ECUs, etc.)

Computer-executable instructions (e.g., software instructions, etc.) may be read into memory 1913 and/or storage component 1914 from another computer-readable medium or from another device (e.g., a remote server, an external storage, etc.) via, for example, the communication interface 1917. When executed, the computer-executable instructions stored in memory 1913 and/or storage component 1914 may cause the processor 1912 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying process claims present elements of the various blocks in a sample order, and are not meant to be limited to the specific order or hierarchy presented.

Some embodiments may relate to a system, a process, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, processes, and computer-readable media according to various embodiments. In this regard, each block in the flowchart or block diagrams may represent a module, segment, or portion of instructions, which comprises one or more executable instructions for implementing the specified logical function(s). The process, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or processes, described herein, may be implemented in different forms of hardware, firmware, or a combination of hardware and software. The actual specialized control hardware or software code used to implement these systems and/or processes is not limiting of the implementations. Thus, the operation and behavior of the systems and/or processes were described herein without reference to specific software code—it being understood that software and hardware may be designed to implement the systems and/or processes based on the description herein.

What is claimed is:

1. An electronic device for generating query responses, the electronic device comprising:
at least one processor; and
a memory storage storing instructions which, when executed by the at least one processor, cause the electronic device to:
obtain, from a user, a query in a natural language format;
identify a plurality of keywords associated with the query;
perform graph-based retrieval-augmented generation (RAG) based on the plurality of keywords to identify a plurality of sub-graphs from a knowledge graph relevant to the query; and
generate a response to the query based on the plurality of sub-graphs.

2. The electronic device according to claim 1, wherein the instructions, when executed by the at least one processor, further cause the electronic device to:
segment the query into a plurality of subqueries,
perform the graph-based RAG to identify multiple pluralities of sub-graphs relevant to the plurality of subqueries, and
generate the response based on an aggregation of the multiple pluralities of sub-graphs.

3. The electronic device according to claim 2, wherein the instructions, when executed by the at least one processor, further cause the electronic device to:
determine whether the query should be segmented into the plurality of subqueries based on a predefined criteria, and
segment the query into the plurality of subqueries based on determining that the query should be segmented into the plurality of subqueries.

4. The electronic device according to claim 1, wherein the instructions, when executed by the at least one processor, further cause the electronic device to generate a plurality of summary entries describing the plurality of sub-graphs, and
wherein the response to the query is generated based on the plurality of summary entries.

5. The electronic device according to claim 1, wherein the knowledge graph comprises a plurality of graph nodes and a plurality of connections between the plurality of graph nodes,
wherein, to perform the graph-based RAG, the instructions, when executed by the at least one processor, further cause the electronic device to:
select a plurality of seed nodes from the plurality of graph nodes based on relevance scores indicating relevance between the plurality of graph nodes and the plurality of keywords, and
select, for each seed node from among the plurality of seed nodes, a plurality of flow-selected nodes from the plurality of graph nodes connected to the each seed node using a flow diffusion process, and
wherein the plurality of seed nodes, the plurality of flow-selected nodes, and connections between the plurality of seed nodes and the plurality of flow-selected nodes form the plurality of sub-graphs.

6. The electronic device according to claim 5, wherein the instructions, when executed by the at least one processor, further cause the electronic device to select the plurality of flow-selected nodes using the flow diffusion process in combination with iterative mass redistribution under a push-relabel algorithm.

7. The electronic device according to claim 5, wherein, to select the plurality of seed nodes, the instructions, when executed by the at least one processor, further cause the electronic device to:
determine, for each graph node from among the plurality of graph nodes, a relevance level between the each graph node and each keyword from among the plurality of keywords,
identify, for the each graph node, a relevance level between the each graph node and a keyword having a highest relevance level from among the plurality of keywords, wherein the highest relevance level corresponds to a relevance score of the each graph node, and
select a number of graph nodes from the plurality of graph nodes having higher relevance scores than remaining graph nodes from among the plurality of graph nodes, wherein the selected number of graph nodes correspond to the plurality of seed nodes.

8. The electronic device according to claim 5, wherein, to select the plurality of flow-selected nodes, the instructions, when executed by the at least one processor, further cause the electronic device to:
determine an initial distribution of a plurality of source mass values by determining a source mass value corresponding to the each seed node;
perform an iterative propagation process to redistribute the plurality of source mass values through the knowledge graph;
compute a plurality of importance scores based on the redistributed plurality of mass values; and
select the plurality of flow-selected nodes based on a comparison between the plurality of importance scores and a predetermined threshold score, and
wherein the plurality of source mass values are redistributed based on a plurality of query-aware edge weights that are computed based on relevance levels between connected nodes and relevance levels between the connected nodes and the query.

9. The electronic device according to claim 8, wherein, to perform the iterative propagation process, the instructions, when executed by the at least one processor, further cause the electronic device to:
determine a sink capacity value corresponding to the each graph node based on a degree of the each graph node;
determine whether an accumulated source mass value associated with the each graph node is greater than the sink capacity value;
based on determining that the accumulated source mass value is greater than the sink capacity value, compute at least one query-aware edge weight corresponding to at least one neighboring node based on a relevance level between the each identified graph node and the at least one neighboring node, a relevance level between the each identified graph node and the query, and a relevance level between the at least one neighboring node and the query; and
distribute an excess mass value to the at least one neighboring node proportionally according to the at least one query-aware edge weight,
wherein the iterative propagation process is repeated until a total excess mass value is less than a convergence threshold value.

10. A method for generating query responses, the method comprising:
obtaining, from a user, a query in a natural language format;
identifying a plurality of keywords associated with the query;
performing graph-based retrieval-augmented generation (RAG) based on the plurality of keywords to identify a plurality of sub-graphs from a knowledge graph relevant to the query; and
generating a response to the query based on the plurality of sub-graphs.

11. The method according to claim 10, further comprising segmenting the query into a plurality of subqueries,
wherein the graph-based RAG is performed to identify multiple pluralities of sub-graphs relevant to the plurality of subqueries, and
wherein the response is generated based on an aggregation of the multiple pluralities of sub-graphs.

12. The method according to claim 11, further comprising determining whether the query should be segmented into the plurality of subqueries based on a predefined criteria,
wherein the query is segmented into the plurality of subqueries in response to determining that the query should be segmented into the plurality of subqueries.

13. The method according to claim 10, further comprising generating a plurality of summary entries describing the plurality of sub-graphs,
wherein the response to the query is generated based on the plurality of summary entries.

14. The method according to claim 10, wherein the knowledge graph comprises a plurality of graph nodes and a plurality of connections between the plurality of graph nodes,
wherein the performing the graph-based RAG comprises:
selecting a plurality of seed nodes from the plurality of graph nodes based on relevance scores indicating relevance between the plurality of graph nodes and the plurality of keywords; and
selecting, for each seed node from among the plurality of seed nodes, a plurality of flow-selected nodes from the plurality of graph nodes connected to the respective seed node using a flow diffusion process, and
wherein the plurality of seed nodes, the plurality of flow-selected nodes, and connections between the plurality of seed nodes and the plurality of flow-selected nodes form the plurality of sub-graphs.

15. The method according to claim 14, wherein the plurality of flow-selected nodes are selected using the flow diffusion process in combination with iterative mass redistribution under push-relabel algorithm.

16. The method according to claim 14, wherein the selecting the plurality of seed nodes comprises:
determining, for each graph node from among the plurality of graph nodes, a relevance level between the each graph node and each keyword from among the plurality of keywords;
identifying, for the each graph node, a relevance level between the each graph node and a keyword having a highest relevance level from among the plurality of keywords, wherein the highest relevance level corresponds to a relevance score of the each graph node; and
selecting a number of graph nodes from the plurality of graph nodes having higher relevance scores than remaining graph nodes from among the plurality of graph nodes, wherein the selected number of graph nodes correspond to the plurality of seed nodes.

17. The method according to claim 14, further comprising:
determining an initial distribution of a plurality of source mass values by determining a source mass value corresponding to the each seed node;
performing an iterative propagation process to redistribute the plurality of source mass values through the knowledge graph;
computing a plurality of importance scores based on the redistributed plurality of mass values; and
selecting the plurality of flow-selected nodes based on a comparison between the plurality of importance scores and a predetermined threshold score,
wherein the plurality of source mass values are redistributed based on a plurality of query-aware edge weights that are computed based on relevance levels between connected nodes and relevance levels between the connected nodes and the query.

18. The method according to claim 17, wherein, the iterative propagation process further comprises:
determining a sink capacity value corresponding to the each graph node based on a degree of the each graph node;
determining whether an accumulated source mass value associated with the each graph node is greater than the sink capacity value;
based on determining that the accumulated source mass value is greater than the sink capacity value, computing at least one query-aware edge weight corresponding to at least one neighboring node based on a relevance level between the each identified graph node and the at least one neighboring node, a relevance level between the each identified graph node and the query, and a relevance level between the at least one neighboring node and the query; and
distributing an excess mass value to the at least one neighboring node proportionally according to the at least one query-aware edge weight, and
wherein the iterative propagation process is repeated until a total excess mass value is less than a convergence threshold value.

19. A non-transitory computer-readable recording medium having recorded thereon instructions which, when executed by at least one processor of an electronic device for generating query responses, cause the electronic device to:
obtain, from a user, a query in a natural language format;
identify a plurality of keywords associated with the query;
perform graph-based retrieval-augmented generation (RAG) based on the plurality of keywords in order to identify a plurality of sub-graphs from a knowledge graph relevant to the query; and
generate a response to the query based on the plurality of sub-graphs.

20. The non-transitory computer-readable recording medium according to claim 19,
wherein the instructions, when executed by the at least one processor, further cause the electronic device to segment the query into a plurality of subqueries,
wherein the graph-based RAG is performed to identify multiple pluralities of sub-graphs relevant to the plurality of subqueries, and
wherein the response is generated based on an aggregation of the multiple pluralities of sub-graphs.
